(19) United States
(12) Patent Application Publication
(10) Pub. No.: US 2012/0287102 A1
(43) Pub. Date: Nov. 15, 2012

(54) PIXEL CIRCUIT, DISPLAY DEVICE, ELECTRONIC APPARATUS, AND METHOD FOR DRIVING PIXEL CIRCUIT

(75) Inventors: Naobumi Toyomura, Kanagawa (JP); Katsuhide Uchino, Kanagawa (JP)

(73) Assignee: Sony Corporation, Tokyo (JP)

(21) Appl. No.: 13/445,572

(22) Filed: Apr. 12, 2012

(30) Foreign Application Priority Data
May 13, 2011 (JP) 2011-107911

(51) Int. Cl. G09G 5/00

(52) U.S. Cl. 345/211

(57) ABSTRACT

A pixel circuit includes a display part, hold capacitance, a write transistor that writes a drive voltage corresponding to a video signal to the hold capacitance, and a drive transistor that drives the display part based on the drive voltage written to the hold capacitance. The pixel circuit is so configured as to be capable of controlling opening and closing of a current path of the display part in association with processing of writing the drive voltage corresponding to the video signal to the hold capacitance.

### BACKGROUND

The technique disclosed in the present specification relates to a pixel circuit, a display device, an electronic apparatus, and a method for driving a pixel circuit (display device).

Today, display devices having pixel circuits (referred to also as pixels) including display elements (referred to also as electro-optical elements) and electronic apparatus including a display device are widely utilized. There are display devices using electro-optical elements whose luminance changes depending on the applied voltage or flowing current as the display elements of the pixels. For example, a liquid crystal display element is a representative example of the electro-optical element whose luminance changes depending on the applied voltage and an organic electro luminescence (organic light emitting diode, OLED; referred to as organic EL, hereinafter) element is a representative example of the electro-optical element whose luminance changes depending on the flowing current. The organic EL display device using the latter, i.e. the organic EL element, is a so-called self-emitting display device using electro-optical elements that are self-luminous elements as the display elements of the pixels.

By the way, in the display device using the display elements, a simple (passive) matrix system and an active matrix system can be employed as the driving system thereof. However, the display device of the simple matrix system has e.g. a problem that realization of a large-size, high-definition display device is difficult although the structure is simple.

Therefore, in recent years, development is being actively promoted about an active matrix system in which a pixel signal supplied to the display element inside the pixel is controlled by using an active element provided inside the pixel as with the display element, specifically e.g. a transistor such as an insulated-gate field effect transistor (generally thin film transistor (TFT)), as a switching transistor.

In display devices of the active matrix system of the related art, the threshold voltage and mobility of the transistor to drive the display element vary due to process variation. Furthermore, the characteristics of the display element change over time. Such characteristic variation of the transistor for driving and characteristic change of the element configuring the pixel circuit, such as the display element, give an influence to the emission luminance. Specifically, although all pixels should emit light with the same luminance and the evenness (uniformity) of the screen should be achieved when a video signal of the same level is supplied to all pixels, the uniformity of the screen is impaired by the characteristic variation of the transistor for driving and the characteristic change of the display element. So, to uniformly control the emission luminance over the whole screen of the display device, techniques to correct display unevenness attributed to characteristic variation and so forth of elements configuring the pixel circuit, such as a transistor and the display element, in the respective pixel circuits have been proposed in e.g. Japanese Patent No. 4240059 and Japanese Patent No. 4240068.

### SUMMARY

However, it is found that the uniformity of the screen is often impaired attributed to turning-on of the electro-optical element in processing of supplying a current to hold capacitance via a drive transistor while writing a drive voltage corresponding to the video signal to the hold capacitance.

There is a need for the present disclosure to provide a technique capable of suppressing a display unevenness phenomenon attributed to turning-on of the electro-optical element in processing of supplying a current to the hold capacitance via the drive transistor while writing the drive voltage corresponding to the video signal to the hold capacitance.

According to a first embodiment of the present disclosure, there is provided a pixel circuit including: a display part; hold capacitance; a write transistor configured to write a drive voltage corresponding to a video signal to the hold capacitance; and a drive transistor configured to drive the display part based on the drive voltage written to the hold capacitance. The pixel circuit is so configured as to be capable of controlling opening and closing of a current path of the display part in association with processing of writing the drive voltage corresponding to the video signal to the hold capacitance. The respective pixel circuits set forth in the appended claims of the pixel circuit according to the embodiment of the present disclosure define more advantageous specific examples of the pixel circuit according to the embodiment of the present disclosure.

According to a second embodiment of the present disclosure, there is provided a display device including display elements configured to be arranged and include a display part, hold capacitance, a write transistor that writes a drive voltage corresponding to a video signal to the hold capacitance, and a drive transistor that drives the display part based on the drive voltage written to the hold capacitance. The display device further includes a control section configured to be capable of controlling opening and closing of a current path of the display part in association with processing of writing the drive voltage corresponding to the video signal to the hold capacitance. The respective techniques and schemes set forth in the appended claims of the pixel circuit according to the first embodiment can be similarly applied to the display device according to the second embodiment, and the configurations to which they are applied define more advantageous specific examples of the display device according to the second embodiment.

According to a third embodiment of the present disclosure, there is provided an electronic apparatus including a pixel section configured to include display elements that are arranged and include a display part, hold capacitance, a write transistor that writes a drive voltage corresponding to a video signal to the hold capacitance, and a drive transistor that drives the display part based on the drive voltage written to the hold capacitance. The electronic apparatus further includes a signal generator configured to generate the video signal to be supplied to the pixel section, and a control section configured to be capable of controlling opening and closing of a current path of the display part in association with processing of writing the drive voltage corresponding to the video signal to the hold capacitance. The respective techniques and schemes set forth in the appended claims of the pixel circuit according to the first embodiment can be similarly applied to the electronic apparatus according to the third embodiment, and the configurations to which they are applied define more advantageous specific examples of the electronic apparatus according to the third embodiment.

According to a fourth embodiment of the present disclosure, there is provided a method for driving a pixel circuit including a drive transistor that drives a display part. The method includes controlling opening and closing of a current path of the display part in association with processing of writing a drive voltage corresponding to a video signal to hold capacitance. The respective techniques and schemes set forth in the appended claims of the pixel circuit according to the first embodiment can be similarly applied to the method for driving a pixel circuit according to the fourth embodiment, and the configurations to which they are applied define more advantageous specific examples of the method for driving a pixel circuit according to the fourth embodiment.

In essence, in the technique disclosed in the present specification, opening and closing of the current path of the display part is controlled in association with the processing of writing the drive voltage corresponding to the video signal to the hold capacitance. The current path of the display part can be closed (blocked) in the certain period corresponding to the processing of supplying a current to the hold capacitance via the drive transistor while writing the drive voltage corresponding to the video signal to the hold capacitance. The current path of the display part can be closed for the certain period so that the occurrence of turning-on of the display part may be prevented. The “certain period” may be so defined that the display part is prevented from being turned on even if a current is made to flow to the display part in this period. By utilizing this technique in the processing of writing the drive voltage corresponding to the video signal to the hold capacitance, the display unevenness phenomenon attributed to the turning-on of the display part can be prevented.

The pixel circuit according to the first embodiment, the display device according to the second embodiment, the electronic apparatus according to the third embodiment, and the method for driving a pixel circuit according to the fourth embodiment can suppress the display unevenness phenomenon attributed to the turning-on of the electro-optical element in the processing of supplying a current to the hold capacitance via the drive transistor while writing the drive voltage corresponding to the video signal to the hold capacitance.

### BRIEF DESCRIPTION OF THE DRAWINGS

FIG. 1 is a block diagram showing the outline of one configuration example of an active matrix display device;

FIG. 2 is a block diagram showing the outline of one configuration example of an active matrix display device capable of color image displaying;

FIG. 3 is a diagram for explaining a light emitting element (substantially pixel circuit);

FIG. 4 is a diagram showing one form of a pixel circuit of a comparative example;

FIG. 5 is a diagram showing the overall outline of a display device including the pixel circuit of the comparative example;

FIG. 6 is a diagram showing one form of a pixel circuit of embodiment example 1;

FIG. 7 is a diagram (first example) showing the overall outline of a display device including the pixel circuit of embodiment example 1;

FIG. 8 is a diagram (second example) showing the overall outline of a display device including the pixel circuit of embodiment example 1;

FIG. 9 is a timing chart for explaining a driving method of the pixel circuit of the comparative example;

FIG. 10A to FIG. 10G are diagrams for explaining an equivalent circuit and operation state in major periods in the timing chart shown in FIG. 9;

FIG. 11 is a timing chart for explaining a driving method of the pixel circuit of embodiment example 1 with focus on countermeasures against display unevenness attributed to a turn-on phenomenon of an organic EL element in a mobility correction period;

FIG. 12 is a diagram showing one form of a pixel circuit of embodiment example 2;

FIG. 13 is a diagram showing the overall outline of a display device including the pixel circuit of embodiment example 2;

FIG. 14 is a diagram showing one form of a pixel circuit of embodiment example 3;

FIG. 15 is a diagram showing the overall outline of a display device including the pixel circuit of embodiment example 3;

FIG. 16 is a timing chart for explaining a driving method of the pixel circuit of embodiment example 3 with focus on countermeasures against display unevenness attributed to the turn-on phenomenon of the organic EL element in the mobility correction period; and

FIG. 17A to FIG. 17E are diagrams for explaining embodiment example 4 (electronic apparatus).

### DETAILED DESCRIPTION OF THE PREFERRED EMBODIMENT

An embodiment of the technique disclosed in the present specification will be described in detail below with reference to the drawings. When distinctions are made among the respective functional elements based on their forms, they are each described with a reference element of an alphabet or “_n” (n is a number) or a combination of them. When being explained without particular distinction, they are described with omission of this reference element. This applies also to the drawings.

The order of the description is as follows.

### 1. Overall Outline

### 2. Outline of Display Device

### 3. Light Emitting Element

### 4. Driving Method: Basics

### 5. Specific Application Examples:

coping with display unevenness phenomenon attributed to turning-on of electro-optical element (control of opening and closing of current path of electro-optical element)

Embodiment Example 1: transistor is connected in series between source of drive transistor and display part+control of opening and closing in association with write drive pulse

Embodiment Example 2: embodiment example 1+auxiliary capacitance

Embodiment Example 3: transistor is connected in series between source of drive transistor and display part+control of opening and closing independently of write drive pulse+auxiliary capacitance

Embodiment Example 4: case examples of application to electronic apparatus

### <Overall Outline>

In the configuration of the present embodiment, a pixel circuit, a display device, or an electronic apparatus includes a display part, hold capacitance, a write transistor to write a drive voltage corresponding to a video signal to the hold capacitance, and a drive transistor to drive the display part based on the drive voltage written to the hold capacitance. Furthermore, opening and closing of the current path of the display part is controlled in association with processing of writing the drive voltage corresponding to the video signal to the hold capacitance.

The opening and closing of the current path of the display part is so controlled that the display part is not turned on in a certain period corresponding to processing of supplying a current to the hold capacitance via the drive transistor while writing the drive voltage corresponding to the video signal to the hold capacitance. It is enough that the display part is prevented from being turned on in this period, in other words, it is enough that a current is prevented from flowing to the display part in this period. Alternatively, it is enough that the current is interrupted before the turning-on even if the current is allowed to flow. Therefore, the range of the “certain period” is so defined that this condition is satisfied. This can prevent the phenomenon in which the display part is turned on in the period of the processing of supplying a current to the hold capacitance via the drive transistor while writing the drive voltage corresponding to the video signal to the hold capacitance, and can prevent the display unevenness phenomenon attributed to turning-on of the display part.

Preferably, as the component capable of controlling opening and closing of the current path of the display part, a transistor is used as a current path control transistor. It is enough that the current path control transistor is disposed on the current path of the display part. That is, it is enough that the current path control transistor capable of controlling opening and closing of the current path of the display part is provided for each display element. For example, it may be connected in series between the connecting node of the main electrode terminal of the drive transistor with the hold capacitance and one terminal of the display part. Alternatively, it may be connected in series between the other terminal of the display part and a reference potential node.

On/off-control of the current path control transistor may be carried out in association with a write drive pulse to control the write transistor or independently of the write drive pulse to control the write transistor. It is preferable to provide a current path control scanner as a functional section to carry out on/off-control of the current path control transistor. The type of the transistor serving as the current path control transistor may be either an n-channel type or a p-channel type, and the polarity of the control pulse is so set as to match the polarity thereof.

Preferably, auxiliary capacitance is provided. In addition, one terminal thereof is connected to the connecting node between the other terminal of the hold capacitance and one main electrode terminal of the drive transistor, and the other terminal thereof is connected to a predetermined reference potential node. The “predetermined reference potential node” may be e.g. the main electrode terminal of the drive transistor on the power supply line side or a reference potential node on the other terminal side of the display part.

Preferably, the auxiliary capacitance has almost the same capacitance value as that of the parasitic capacitance of the display part.

Preferably, connection of the auxiliary capacitance is so configured as to be capable of being blocked in association with the processing of writing the drive voltage corresponding to the video signal to the hold capacitance. It is preferable to use a transistor as the component capable of controlling the connection of the auxiliary capacitance.

Preferably, processing of supplying a current to the hold capacitance via the drive transistor while supplying the video signal to the control input terminal of the drive transistor and one terminal of the hold capacitance via the write transistor is utilized as mobility correction processing of correcting the mobility of the drive transistor.

Preferably, this processing is used in conjunction with correction processing of the threshold voltage of the drive transistor. In this case, it is preferable to execute processing of supplying a current to the hold capacitance via the drive transistor after the correction processing of the threshold voltage of the drive transistor, i.e. carry out the mobility correction after the threshold correction. Furthermore, preferably, the current path of the display part is not blocked in the correction processing of the threshold voltage.

As the device configuration, the number of pixel circuits (display parts) may be one. Furthermore, a configuration including the pixel section in which the display parts are arranged in a line manner or a two-dimensional matrix manner may also be employed. In the case of a configuration including the pixel section, it is preferable to provide a control section that carries out block control of the current path of the display part in association with the processing of supplying a current to the hold capacitance via the drive transistor while writing the drive voltage corresponding to the video signal to the hold capacitance. It is preferable that a scanning section serving as part of the control section be provided separately from the display part (display element). In the case of a configuration including the pixel section in which the display parts are arranged in a two-dimensional matrix manner, it is possible to employ a configuration to carry out block control of the current path of the display part on a row-by-row basis by scanning processing.

As the display part, e.g. a light emitting element including a self-luminous light emitting part such as an organic electroluminescence light emitting part, an inorganic electroluminescence light emitting part, an LED light emitting part, and a semiconductor laser light emitting part can be used. In particular, the organic electroluminescence light emitting part is preferable.

### <Outline of Display Device>

In the following description, the resistance value, capacitance value (capacitance), and so forth of the circuit constituent component are often shown with the same symbol as that given to the component in order to facilitate understanding of the correspondence relationship.

### [Basics]

First, the outline of the display device including the light emitting element will be described. In the following description of the circuit configuration, “electrically connect” is expressed simply as “connect,” and this “electrically connect” is not limited to direct connection and includes also connection via another transistor (switching transistor is a typical example) and another electrical element (it is not limited to an active element and may be a passive element) unless there is a particular explicit note.

The display device includes plural pixel circuits (or they will be often referred to simply as the pixels). Each pixel circuit has a display element (electro-optical element) including a light emitting part and a drive circuit that drives the light emitting part. As the display part, e.g. a light emitting element including a self-luminous light emitting part such as an organic electroluminescence light emitting part, an inorganic electroluminescence light emitting part, an LED light emitting part, and a semiconductor laser light emitting part can be used. A constant-current driving type is employed as the system to drive the light emitting part of the display element. However, the system is not limited to the constant-current driving type and may be a constant-voltage driving type in terms of the principle.

In the example described below, the light emitting element includes an organic electroluminescence light emitting part. Specifically, the light emitting element is an organic electroluminescence element (organic EL element) having a structure obtained by stacking the drive circuit and the organic electroluminescence light emitting part (light emitting part ELP) connected to the drive circuit.

Although various kinds of circuits are available as the drive circuit for driving the light emitting part ELP, the pixel circuit can have a configuration including the drive circuit of e.g. a 5Tr/1C type, a 4Tr/1C type, a 3Tr/1C type, or a 2Tr/1C type. Symbol α in “αTr/1C type” means the number of transistors and “1C” means that the capacitive part includes one hold capacitance C_{cs} (capacitor). It is preferable that all of the respective transistors configuring the drive circuit be formed of an n-channel transistor. However, the configuration is not limited thereto and part of the transistors may be a p-channel transistor depending on the case. It is also possible to employ a configuration in which the transistors are formed on a semiconductor substrate or the like. The structure of the transistor configuring the drive circuit is not particularly limited and an insulated-gate field effect transistor (generally thin film transistor (TFT)) typified by the MOSFET can be used. Furthermore, the transistor configuring the drive circuit may be either an enhancement-type transistor or a depletion-type transistor, and may be either a single-gate transistor or a dual-gate transistor.

In any configuration, basically the display device includes the light emitting part ELP, the drive transistor TR_{D}, the write transistor TR_{W} (referred to also as the sampling transistor), a vertical scanner including at least a write scanner, a horizontal driver having the functions of a signal output section, and the hold capacitance C_{cs} similarly to the 2Tr/1C type as the minimum constituent element. Preferably, to form a bootstrap circuit, the hold capacitance C_{cs} is connected between the control input terminal (gate terminal) of the drive transistor TR_{D} and one of the main electrode terminals (source/drain regions) thereof (typically source terminal). One of the main electrode terminals of the drive transistor TR_{D} is connected to the light emitting part ELP and the other of the main electrode terminals thereof is connected to a power supply line PWL. A supply voltage (steady voltage or pulse-like voltage) is supplied from e.g. a power supply circuit or a scanning circuit for the power supply voltage to the power supply line PWL.

The horizontal driver supplies, to a video signal line DTL (referred to also as the data line), a video signal VS in a broad sense representing a video signal V_{sig} for controlling the luminance of the light emitting part ELP and a reference potential (the number of kinds thereof is not limited to one) used for threshold correction and so forth. One of the main electrode terminals of the write transistor TR_{W} is connected to the video signal line DTL and the other of the main electrode terminals thereof is connected to the control input terminal of the drive transistor TR_{D}. The write scanner supplies a control pulse (write drive pulse WS) for on/off-control of the write transistor TR_{W} to the control input terminal of the write transistor TR_{W} via a write scan line WSL. The connecting node among the other of the main electrode terminals of the write transistor TR_{W}, the control input terminal of the drive transistor TR_{D}, and one terminal of the hold capacitance C_{cs} will be referred to as a first node ND₁, and the connecting node between one of the main electrode terminals of the drive transistor TR_{D} and the other terminal of the hold capacitance C_{cs} will be referred to as a second node ND₂.

### Configuration Example

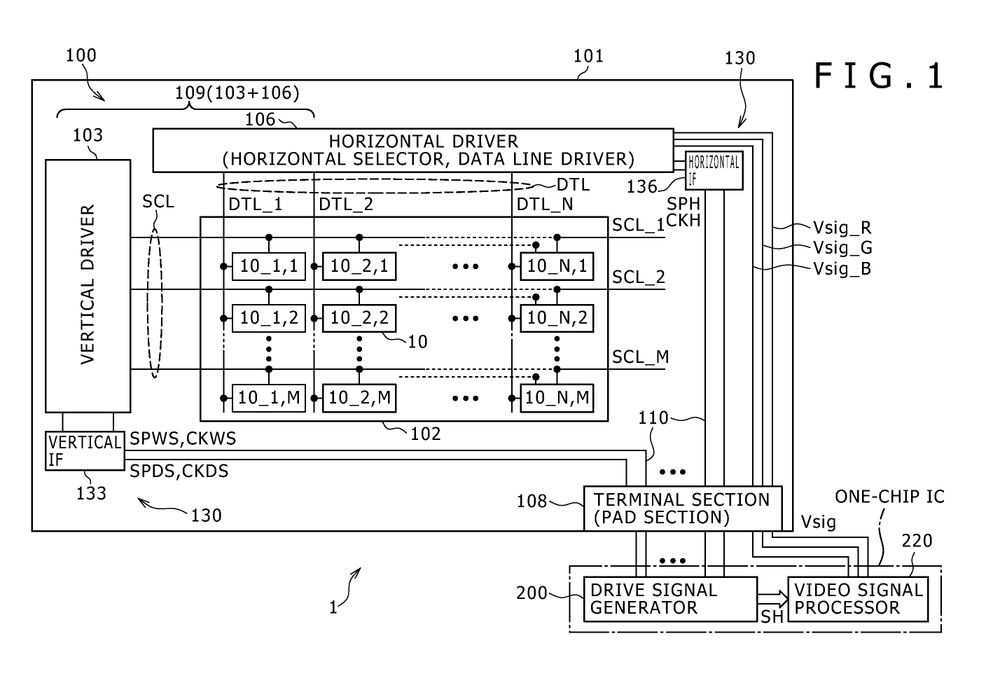

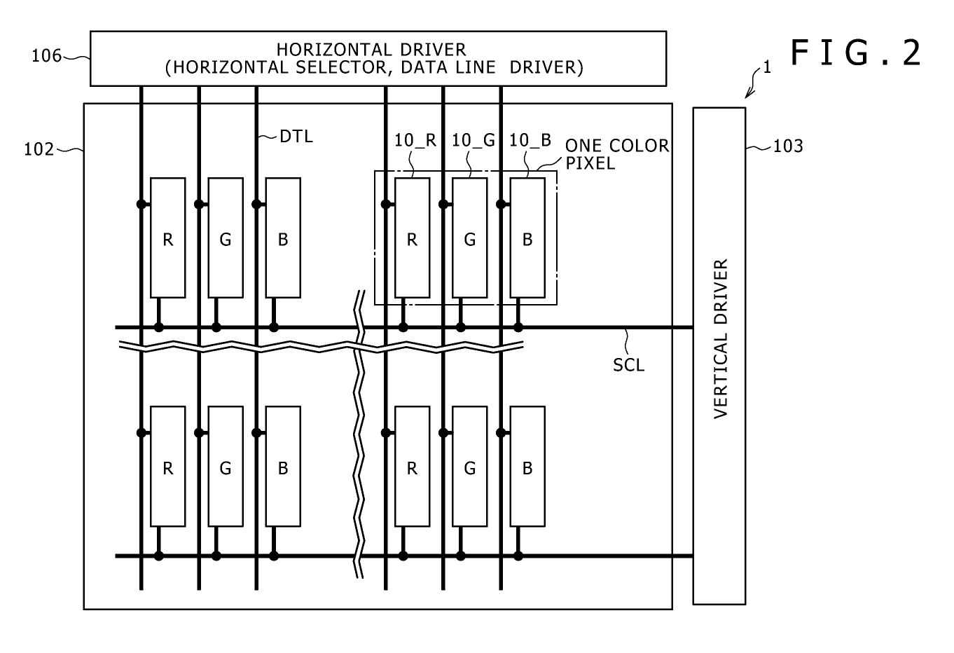

FIG. 1 and FIG. 2 are block diagrams showing the outline of one configuration example of an active matrix display device as a display device of one embodiment of the present disclosure. FIG. 1 is a block diagram showing the outline of the configuration of a general active matrix display device, and FIG. 2 is a block diagram showing the outline of the case in which it is capable of color image displaying.

As shown in FIG. 1, a display device 1 includes a display panel block 100 in which pixel circuits 10 (referred to also as the pixels) having organic EL elements (not shown) as plural display elements are so disposed as to configure an effective video area whose vertical-to-horizontal ratio as the display aspect ratio is X to Y (e.g. 9 to 16). Furthermore, the display device 1 includes a drive signal generator 200 (so-called timing generator) as one example of a panel control section that outputs various pulse signals to carry out drive control of this display panel block 100, and a video signal processor 220. The drive signal generator 200 and the video signal processor 220 are incorporated in a one-chip integrated circuit (IC; semiconductor integrated circuit) and are disposed outside the display panel block 100 in the present example.

The product form is not limited to such a form as to be provided as the display device 1 in a module (compound component) form including all of the display panel block 100, the drive signal generator 200, and the video signal processor 220 as shown in the diagram. For example, a form including only the display panel block 100 may be provided as the display device 1. Furthermore, the forms of the display device 1 include a form having a module shape with a sealed configuration. For example, a display module formed by attaching an opposing part of e.g. transparent glass to a pixel array section 102 falls into this form. The transparent opposing part may be provided with a color filter, a protective film, a light blocking film, etc. The display module may be provided with a circuit section, a flexible printed circuit (FPC), etc. for input/output of the video signal V_{sig} and various kinds of drive pulses from the external to the pixel array section 102.

Such a display device 1 can be utilized as a display section of various pieces of electronic apparatus, specifically electronic apparatus in every field that displays a video signal input to the electronic apparatus or a video signal generated in the electronic apparatus as still images and moving images (video). Examples of the electronic apparatus include portable music players utilizing recording media such as semiconductor memory, Mini Disc (MD), and cassette tape, digital cameras, notebook personal computers, portable terminal devices such as cellular phones, and video camcorders.

In the display panel block 100, e.g. the following components are integrally formed over a substrate 101: the pixel array section 102 in which the pixel circuits 10 are arranged in a matrix of M rows×N columns; a vertical driver 103 that scans the pixel circuits 10 in the vertical direction; a horizontal driver 106 (referred to also as horizontal selector or data line driver) that scans the pixel circuits 10 in the horizontal direction; an interface section 130 (IF) that interfaces the respective drivers (vertical driver 103 and horizontal driver 106) with an external circuit; and a terminal section 108 (pad section) for external connection. That is, the display panel block 100 has a configuration in which the peripheral drive circuits such as the vertical driver 103, the horizontal driver 106, and the interface section 130 are formed over the same substrate 101 as that of the pixel array section 102. The light emitting element (pixel circuit 10) located on the m-th row (m=1, 2, 3, . . . , M) and the n-th column (n=1, 2, 3, . . . , N) is indicated by 10_{—}n, m in the diagram.

The interface section 130 has a vertical IF section 133 that interfaces the vertical driver 103 with an external circuit, and a horizontal IF section 136 that interfaces the horizontal driver 106 with an external circuit.

The vertical driver 103 and the horizontal driver 106 configure a control section 109 that controls writing of the signal potential to the hold capacitance, threshold correction operation, mobility correction operation, and bootstrap operation. Circuitry including this control section 109 and the interface section 130 (vertical IF section 133 and horizontal IF section 136) configures a drive control circuit that carries out drive control of the pixel circuits 10 of the pixel array section 102.

In the case of employing the 2Tr/1C type, the vertical driver 103 has a write scanner (write scan (WS)) and a drive scanner (drive scan (DS)) that functions as a power supply scanner having power supply capability. As one example, the pixel array section 102 is driven by the vertical driver 103 from one side or both sides of the left and right directions in the diagram, and is driven by the horizontal driver 106 from one side or both sides of the upper and lower directions in the diagram.

To the terminal section 108, various pulse signals are supplied from the drive signal generator 200 disposed outside the display device 1. Similarly, the video signal V_{sig} is supplied from the video signal processor 220. In the case of the display device capable of color displaying, video signal V_{sig}_{_{—}}_{R}, video signal V_{sig}_{_{—}}_{G}, and video signal V_{sig}_{_{—}}_{B} that are different for each of colors (three primary colors of red (R), green (G), and blue (B) in the present example) are supplied.

As one example, the following desired pulse signals are supplied as pulse signals for vertical driving: a shift start pulse SP (two kinds of pulses SPDS and SPWS in the diagram) as one example of the scan start pulse of the vertical direction; a vertical scan clock CK (two kinds of pulses CKDS and CKWS in the diagram); a vertical scan clock xCK (two kinds of pulses xCKDS and xCKWS in the diagram) obtained by phase inversion according to need; and an enable pulse that orders pulse output at a specific timing. As pulse signals for horizontal driving, the following desired pulse signals are supplied: a horizontal start pulse SPH as one example of the scan start pulse of the horizontal direction, a horizontal scan clock CKH, a horizontal scan clock xCKH obtained by phase inversion according to need, and an enable pulse that orders pulse output at a specific timing.

The respective terminals of the terminal section 108 are connected to the vertical driver 103 and the horizontal driver 106 via wiring 110. For example, the respective pulses supplied to the terminal section 108 are supplied to the respective sections in the vertical driver 103 and the horizontal driver 106 via a buffer after the voltage level is internally adjusted by a level shifter section (not shown) according to need.

The pixel array section 102 has the following configuration. Specifically, the pixel circuits 10 in which pixel transistors are provided for the organic EL element as the display element are two-dimensionally disposed in a matrix manner although not shown in the diagram (details will be described later). Furthermore, for the pixel arrangement, vertical scan lines SCL are wired on a row-by-row basis and video signal lines DTL are wired on a column-by-column basis. That is, the pixel circuits 10 are connected to the vertical driver 103 via the vertical scan lines SCL and are connected to the horizontal driver 106 via the video signal lines DTL. Specifically, for the respective pixel circuits 10 arranged in a matrix, the vertical scan lines SCL_1 to SCL_n for n rows driven by a drive pulse by the vertical driver 103 are wired on each pixel row basis. The vertical driver 103 is configured by a combination of logical gates (including latch, shift register, etc.). It selects the respective pixel circuits 10 of the pixel array section 102 on a row-by-row basis, i.e. sequentially selects the respective pixel circuits 10 via the vertical scan lines SCL based on the pulse signals of the vertical drive system, supplied from the drive signal generator 200. The horizontal driver 106 is configured by a combination of logical gates (including latch, shift register, etc.). It selects the respective pixel circuits 10 of the pixel array section 102 on a column-by-column basis, i.e. makes the selected pixel circuits 10 perform sampling of a predetermined potential (e.g. the level of the video signal V_{sig}) in the video signal VS via the video signal line DTL and write the predetermined potential to the hold capacitance C_{cs} based on the pulse signals of the horizontal drive system, supplied from the drive signal generator 200.

The display device 1 of the present embodiment allows line-sequential driving and dot-sequential driving. Specifically, a write scanner 104 and a drive scanner 105 of the vertical driver 103 scan the pixel array section 102 line-sequentially (i.e. on a row-by-row basis). In addition, in synchronization with this scanning, the horizontal driver 106 writes the image signal to the pixel array section 102 simultaneously for the pixels on one horizontal line (in the case of line-sequential driving) or on a pixel-by-pixel basis (in the case of dot-sequential driving).

To permit the display device to display color images, as shown in FIG. 2 for example, pixel circuit 10_{—R}, pixel circuit 10_{—G}, pixel circuit 10_{—B} as sub-pixels that are different for each of colors (three primary colors of red (R), green (G), and blue (B) in the present example) are provided in a vertical stripe manner in predetermined arrangement order in the pixel array section 102. One color pixel is configured by one set of sub-pixels of the respective colors. Although a layout with a stripe structure obtained by disposing the sub-pixels of the respective colors in a vertical stripe manner is shown as one example of the sub-pixel layout in this diagram, the sub-pixel layout is not limited to such an arrangement example. A form obtained by shifting the sub-pixels in the vertical direction may be employed.

Although FIG. 1 and FIG. 2 show a configuration in which the vertical driver 103 (specifically constituent elements thereof) is disposed only on one side of the pixel array section 102, it is also possible to employ a configuration in which the respective elements of the vertical driver 103 are disposed on both of the left and right sides of the pixel array section 102. Furthermore, it is also possible to employ a configuration in which one and the other of the respective elements of the vertical driver 103 are disposed on the left and right sides, respectively, separately from each other. Similarly, although FIG. 1 and FIG. 2 show a configuration in which the horizontal driver 106 is disposed only on one side of the pixel array section 102, it is also possible to employ a configuration in which the horizontal driver 106 is disposed on both of the upper and lower sides of the pixel array section 102. Although the present example has a configuration in which the pulse signals such as the vertical shift start pulse, the vertical scan clock, the horizontal start pulse, and the horizontal scan clock are input from the external of the display panel block 100, it is also possible that the drive signal generator 200 to generate these various kinds of timing pulses is incorporated on the display panel block 100.

The configuration shown in the diagram is merely one form of the display device, and another form can be employed as the product form. Specifically, the display device may have any form as long as the whole of the device includes the pixel array section in which the elements configuring the pixel circuits 10 are disposed in a matrix manner, the control section including, as its main section, the scanner that is disposed around the pixel array section and connected to the scan lines for driving the respective pixels, and the drive signal generator and the video signal processor to generate various kinds of signals for operating the control section. As the product form, besides a form like that shown in the diagram, in which the display panel block obtained by mounting the pixel array section and the control section on the same base (e.g. glass substrate) is disposed as a component separate from the drive signal generator and the video signal processor (referred to as the disposed-on-panel configuration), a form in which the pixel array section is incorporated in the display panel block and the peripheral circuits such as the control section, the drive signal generator, and the video signal processor are mounted on a substrate (e.g. flexible substrate) separate from the display panel block (referred to as the peripheral-circuit-disposed-outside-panel configuration) can be employed. Furthermore, in the case of the disposed-on-panel configuration, in which the display panel block is configured by mounting the pixel array section and the control section on the same base, it is also possible to employ a form in which the respective transistors for the control section (and the drive signal generator and the video signal processor, according to need) are formed simultaneously with a step of forming the TFTs of the pixel array section (referred to as the transistor-integrated configuration), and a form in which a semiconductor chip for the control section (and the drive signal generator and the video signal processor, according to need) is directly mounted on a base on which the pixel array section is mounted by a chip-on-glass (COG) mounting technique (referred to as the COG-mounted configuration). Alternatively, it is also possible to provide a form including only the display panel block (including at least the pixel array section) as the display device.

### <Light Emitting Element>

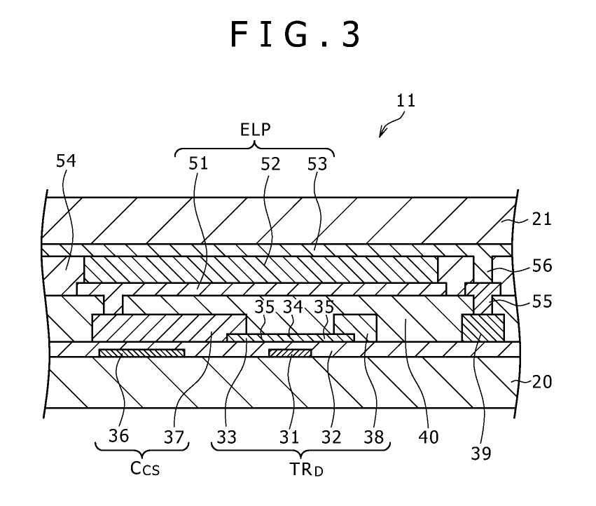

FIG. 3 is a diagram for explaining a light emitting element 11 (substantially the pixel circuit 10) including a drive circuit. FIG. 3 is a schematic partial sectional view of part of the light emitting element 11 (pixel circuit 10). Suppose that an insulated-gate field effect transistor is a thin film transistor (TFT) in FIG. 3. A so-called back-gate thin film transistor or a MOS transistor may be used although not shown in the diagram.

The respective transistors and the capacitive part (hold capacitance C_{cs}) that configure the drive circuit of the light emitting element 11 are formed on a support body 20, and the light emitting part ELP is formed above the respective transistors and the hold capacitance C_{cs} that configure the drive circuit with the intermediary of an interlayer insulating layer 40 for example. One source/drain region of the drive transistor TR_{D} is connected to an anode electrode included in the light emitting part ELP via a contact hole. In FIG. 3, only the drive transistor TR_{D} is shown. The write transistor TR_{W} and the other transistors are hidden and invisible. The light emitting part ELP has well-known configuration and structure such as an anode electrode, a hole transport layer, a light emitting layer, an electron transport layer, and a cathode electrode.

Specifically, the drive transistor TR_{D} is composed of a gate electrode 31, a gate insulating layer 32, a semiconductor layer 33, source/drain regions 35 provided in the semiconductor layer 33, and a channel forming region 34 to which the part of the semiconductor layer 33 between the source/drain regions 35 corresponds. The hold capacitance C_{cs} is composed of the other electrode 36, a dielectric layer formed of an extended part of the gate insulating layer 32, and one electrode 37 (equivalent to the second node ND₂). The gate electrode 31, part of the gate insulating layer 32, and the other electrode 36 configuring the hold capacitance C_{cs} are formed on the support body 20. One source/drain region 35 of the drive transistor TR_{D} is connected to wiring 38 and the other source/drain region 35 is connected to one electrode 37. The drive transistor TR_{D}, the hold capacitance C_{cs}, and so forth are covered by the interlayer insulating layer 40, and the light emitting part ELP composed of an anode electrode 51, a hole transport layer, a light emitting layer, an electron transport layer, and a cathode electrode 53 is provided on the interlayer insulating layer 40. In FIG. 3, the hole transport layer, the light emitting layer, and the electron transport layer are represented as one layer 52. A second interlayer insulating layer 54 is provided on the part of the interlayer insulating layer 40 on which the light emitting part ELP is not provided, and a transparent substrate 21 is disposed over the second interlayer insulating layer 54 and the cathode electrode 53. Light emitted by the light emitting layer passes through the substrate 21 to be output to the external. One electrode 37 and the anode electrode 51 are connected to each other by a contact hole provided in the interlayer insulating layer 40. The cathode electrode 53 is connected to wiring 39 provided on an extended part of the gate insulating layer 32 via a contact hole 56 and a contact hole 55 provided in the second interlayer insulating layer 54 and the interlayer insulating layer 40.

### [Driving Method]

A driving method of the light emitting part will be described below. To facilitate understanding, the description will be made based on the assumption that the respective transistors configuring the pixel circuit 10 are n-channel transistors. Furthermore, suppose that the anode terminal of the light emitting part ELP is connected to the second node ND₂ and the cathode terminal is connected to cathode wiring cath (the potential thereof is defined as the cathode potential V_{cath}). Moreover, the emission state (luminance) in the light emitting part ELP is controlled depending on the magnitude of the value of a drain current I_{ds}. In the emission state of the light emitting element, of two main electrode terminals (source/drain regions) of the drive transistor TR_{D}, one (anode side of the light emitting part ELP) functions as the source terminal (source region) and the other functions as the drain terminal (drain region). Suppose that the display device is capable of color displaying and is composed of (N/3)×M pixel circuits 10 arranged in a two-dimensional matrix, and one pixel circuit as one unit of color displaying is composed of three sub-pixel circuits (red emission pixel circuit 10_{—R} to emit red light, green emission pixel circuit 10_{—G} to emit green light, blue emission pixel circuit 10_{—B} to emit blue light). Suppose that the light emitting elements configuring the respective pixel circuits 10 are line-sequentially driven and the display frame rate is FR (times/second). That is, (N/3) pixel circuits 10 arranged on the m-th row (m=1, 2, 3, . . . , M), specifically the light emitting elements configuring N pixel circuits 10, respectively, are simultaneously driven. In other words, in the respective light emitting elements on one row, the emission/non-emission timing thereof is controlled in units of the row to which they belong. The processing of writing the video signal about the respective pixel circuits 10 on one row may be processing of simultaneously writing the video signal about all pixel circuits 10 (referred to also as simultaneous writing processing) or may be processing of sequentially writing the video signal for each pixel circuit 10 (referred to also as sequential writing processing). Which writing processing is employed is accordingly selected depending on the configuration of the drive circuit.

The drive operation relating to the light emitting element (pixel circuit 10) located on the m-th row and the n-th column (n=1, 2, 3, . . . , N) will be described below. The light emitting element located on the m-th row and the n-th column will be referred to as the (n, m)-th light emitting element or the (n, m)-th light emitting element pixel circuit. Various kinds of processing (threshold correction processing, writing processing, mobility correction processing, etc.) are executed by the time the horizontal scanning period of the respective light emitting elements arranged on the m-th row (m-th horizontal scanning period) ends. The writing processing and the mobility correction processing should be executed in the m-th horizontal scanning period. On the other hand, depending on the kind of drive circuit, the threshold correction processing and pre-processing associated with it can be executed earlier than the m-th horizontal scanning period.

After the end of all of the above-described various kinds of processing, the light emitting parts configuring the respective light emitting elements arranged on the m-th row are made to emit light. The light emitting parts may be made to emit light immediately after the end of all of the various kinds of processing. Alternatively, the light emitting parts may be made to emit light after the elapse of a predetermined period (e.g. horizontal scanning period for a predetermined number of rows). The “predetermined period” is accordingly set depending on the specifications of the display device, the configuration of the pixel circuit 10 (i.e. drive circuit), and so forth. The following description is based on the assumption that the light emitting parts are made to emit light immediately after the end of the various kinds of processing for convenience of explanation. The light emission of the light emitting parts configuring the respective light emitting elements arranged on the m-th row is continued until timing immediately before the start of the horizontal scanning period of the respective light emitting elements arranged on the (m+m′)-th row. This “m′” is decided depending on the design specifications of the display device. That is, the light emission of the light emitting parts configuring the respective light emitting elements arranged on the m-th row in a certain display frame is continued until the (m+m′−1)-th horizontal scanning period. On the other hand, from the start timing of the (m+m′)-th horizontal scanning period to the completion of writing processing and mobility correction processing in the m-th horizontal scanning period in the next display frame, the light emitting parts configuring the respective light emitting elements arranged on the m-th row maintain the non-emission state as a general rule. By setting the period of the non-emission state (referred to also as the non-emission period), the residual image blur accompanying the active matrix driving is reduced and the moving image quality can be made more favorable. However, the emission state/non-emission state of each pixel circuit 10 (light emitting element) is not limited to the above-described state. The time length of the horizontal scanning period is shorter than (1/FR)×(1/M) seconds. If the value of (m+m′) exceeds M, the exceeding part of the horizontal scanning period is processed in the next display frame.

The on-state (conductive state) of a transistor means the state in which a channel is formed between the main electrode terminals (between the source/drain regions) and is irrespective of whether or not a current flows from one main electrode terminal to the other main electrode terminal. The off-state (non-conductive state) of a transistor means the state in which a channel is not formed between the main electrode terminals. That the main electrode terminal of a certain transistor is connected to the main electrode terminal of another transistor encompasses a form in which the source/drain region of the certain transistor and the source/drain region of another transistor occupy the same region. Furthermore, the source/drain region can be formed from not only an electrically-conductive substance such as polysilicon or amorphous silicon containing an impurity but also a layer composed of a metal, an alloy, electrically-conductive particles, a laminated structure of them, or an organic material (electrically-conductive polymer). In addition, in the timing charts used in the following description, the lengths along the abscissa indicating the respective periods (time lengths) are schematic and do not represent the ratio of the time lengths of the respective periods.

The driving method of the pixel circuit 10 has pre-processing step, threshold correction processing step, video signal writing processing step, mobility correction step, and emission step. The pre-processing step, the threshold correction processing step, the video signal writing processing step, and the mobility correction step are collectively referred to also as the non-emission step. Depending on the configuration of the pixel circuit 10, the video signal writing processing step and the mobility correction step are simultaneously executed in some cases. The outline of the respective steps will be described below.

The drive transistor TR_{D} is so driven as to allow the flowing of the drain current I_{ds} in accordance with the following expression (1) in the emission state of the light emitting element. The light emitting part ELP emits light due to the flowing of the drain current I_{ds} through the light emitting part ELP. Furthermore, the emission state (luminance) in the light emitting part ELP is controlled depending on the magnitude of the value of the drain current I_{ds}. In the emission state of the light emitting element, of two main electrode terminals (source/drain regions) of the drive transistor TR_{D}, one (anode terminal side of the light emitting part ELP) functions as the source terminal (source region) and the other functions as the drain terminal (drain region). For convenience of explanation, one main electrode terminal of the drive transistor TR_{D} will be referred to simply as the source terminal and the other main electrode terminal will be referred to simply as the drain terminal in some cases in the following description. The respective parameters are defined as follows. The effective mobility is μ. The channel length is L and the channel width is W. The potential difference (gate-source voltage) between the potential of the control input terminal (gate potential V_{g}) and the potential of the source terminal (source potential Vₛ) is V_{gs}. The threshold voltage is Vₜₕ. The equivalent capacitance is Cₒₓ ((relative dielectric constant of gate insulating layer)×(permittivity of vacuum)/(thickness of gate insulating layer)).

Coefficient k≡(½)·(W/L)·Cₒₓ.

I_{ds}=k·μ·(V_{gs}−Vₜₕ)² (1)

In the following description, unless there is a particular notice, it is assumed that the parasitic capacitance Cₑₗ of the light emitting part ELP is sufficiently higher than the hold capacitance C_{cs} and the gate-source capacitance C_{gs} as one example of the parasitic capacitance of the drive transistor TR_{D}, and change in the potential (source potential Vₛ) of the source region (second node ND₂) of the drive transistor TR_{D} based on change in the potential of the gate terminal (gate potential V_{g}) of the drive transistor TR_{D} is not taken into consideration.

### [Pre-Processing Step]

A first node initialization voltage (V_{ofs}) is applied to the first node ND₁ and a second node initialization voltage (Vᵢₙᵢ) is applied to the second node ND₂ so that the potential difference between the first node ND₁ and the second node ND₂ may surpass the threshold voltage Vₜₕ of the drive transistor TR_{D} and the potential difference between the second node ND₂ and the cathode electrode included in the light emitting part ELP may be prevented from surpassing the threshold voltage V_{thEL} of the light emitting part ELP. For example, the respective voltages are set as follows. The video signal V_{sig} for controlling the luminance in the light emitting part ELP is 0 to 10 volts. The supply voltage V_{cc} is 20 volts. The threshold voltage Vₜₕ of the drive transistor TR_{D} is 3 volts. The cathode potential V_{cath} is 0 volts. The threshold voltage V_{thEL} of the light emitting part ELP is 3 volts. In this case, the potential V_{ofs} for initializing the potential of the control input terminal of the drive transistor TR_{D} (gate potential V_{g}, i.e. the potential of the first node ND₁) is set to 0 volts and the potential Vᵢₙᵢ for initializing the potential of the source terminal of the drive transistor TR_{D} (source potential Vₛ, i.e. the potential of the second node ND₂) is set to −10 volts.

### [Threshold Correction Processing Step]

In the state in which the potential of the first node ND₁ is kept, the drain current I_{ds} is made to flow through the drive transistor TR_{D} to change the potential of the second node ND₂ toward the potential obtained by subtracting the threshold voltage Vₜₕ of the drive transistor TR_{D} from the potential of the first node ND₁. At this time, a voltage (e.g. supply voltage in light emission) that surpasses the voltage obtained by adding the threshold voltage Vₜₕ of the drive transistor TR_{D} to the potential of the second node ND₂ after the pre-processing step is applied to the other of the main electrode terminals of the drive transistor TR_{D} (on the opposite side to the second node ND₂). In this threshold correction processing step, the degree of approximation of the potential difference between the first node ND₁ and the second node ND₂ (in other words, the gate-source voltage V_{gs} of the drive transistor TR_{D}) to the threshold voltage Vₜₕ of the drive transistor TR_{D} depends on the time of the threshold correction processing. Thus, for example if a sufficiently-long time of the threshold correction processing is ensured, the potential of the second node ND₂ reaches the potential obtained by subtracting the threshold voltage Vₜₕ of the drive transistor TR_{D} from the potential of the first node ND₁, so that the drive transistor TR_{D} becomes the off-state. On the other hand, for example if the time of the threshold correction processing cannot help but be set short, the potential difference between the first node ND₁ and the second node ND₂ is higher than the threshold voltage Vₜₕ of the drive transistor TR_{D} and the drive transistor TR_{D} does not become the off-state in some cases. The drive transistor TR_{D} does not necessarily need to become the off-state as the result of the threshold correction processing. In the threshold correction processing step, preferably the potentials are so selected and decided as to satisfy expression (2) to thereby prevent the light emitting part ELP from emitting light.

(V_{ofs}−Vₜₕ)<(V_{thEL}+V_{cath}) (2)

### [Video Signal Writing Processing Step]

The video signal V_{sig} is applied from the video signal line DTL to the first node ND₁ via the write transistor TR_{W} turned to the on-state by the write drive pulse WS from the write scan line WSL, to raise the potential of the first node ND₁ to V_{sig}. The charge based on this potential change of the first node ND₁ (Vᵢₙ=V_{sig}−V_{ofs}) is distributed to the hold capacitance C_{cs}, the parasitic capacitance Cₑₗ of the light emitting part ELP, and the parasitic capacitance of the drive transistor TR_{D} (e.g. gate-source capacitance C_{gs}). If the capacitance Cₑₗ is sufficiently higher than the capacitance C_{cs} and the gate-source capacitance C_{gs}, the change in the potential of the second node ND₂ based on the potential change (V_{sig}−V_{ofs}) is small. In general, the parasitic capacitance Cₑₗ of the light emitting part ELP is higher than the hold capacitance C_{cs} and the gate-source capacitance C_{gs}. In view of this point, potential change of the second node ND₂ arising due to potential change of the first node ND₁ is not taken into consideration unless there is a particular need to consider the potential change. In this case, the gate-source voltage V_{gs} can be represented by expression (3).

V_{g}=V_{sig}

Vₛ≈V_{ofs}−Vₜₕ

V_{gs}≈V_{sig}−(V_{ofs}−Vₜₕ) (3)

### [Mobility Correction Processing Step]

While the video signal V_{sig} is supplied to one terminal of the hold capacitance C_{cs} via the write transistor TR_{W} (i.e. while the drive voltage corresponding to the video signal V_{sig} is written to the hold capacitance C_{cs}), a current is supplied to the hold capacitance C_{cs} via the drive transistor TR_{D}. For example, in the state in which the video signal V_{sig} is supplied to the first node ND₁ from the video signal line DTL via the write transistor TR_{W} turned to the on-state by the write drive pulse WS from the write scan line WSL, power is supplied to the drive transistor TR_{D} to cause the flowing of the drain current I_{ds} to change the potential of the second node ND₂. Then, after the elapse of a predetermined period, the write transistor TR_{W} is turned to the off-state. The potential change of the second node ND₂ at this time is defined as ΔV (=potential correction value, negative feedback amount). The predetermined period for executing the mobility correction processing is decided as a design value in advance in the design of the display device. At this time, preferably the mobility correction period is so decided as to satisfy expression (2A). This prevents the light emitting part ELP from emitting light in the mobility correction period.

(V_{ofs}−Vₜₕ+ΔV)<(V_{thEL}+V_{cath}) (2A)

The potential correction value ΔV is large when the value of the mobility μ of the drive transistor TR_{D} is large, and the potential correction value ΔV is small when the value of the mobility μ is small. The gate-source voltage V_{gs} of the drive transistor TR_{D} (i.e. the potential difference between the first node ND₁ and the second node ND₂) at this time can be represented by expression (4). Although the gate-source voltage V_{gs} defines the luminance in light emission, the potential correction value ΔV is in proportion to the drain current I_{ds} of the drive transistor TR_{D} and the drain current I_{ds} is in proportion to the mobility μ. Consequently, the potential correction value ΔV is larger when the mobility μ is higher and thus variation in the mobility μ on each pixel circuit 10 basis can be eliminated.

V_{gs}≈V_{sig}−(V_{ofs}−Vₜₕ)−ΔV (4)

### [Emission Step]

The first node ND₁ is set to the floating state by turning the write transistor TR_{W} to the off-state by the write drive pulse WS from the write scan line WSL, and power is supplied to the drive transistor TR_{D} to cause the current I_{ds} depending on the gate-source voltage V_{gs} of the drive transistor TR_{D} (potential difference between the first node ND₁ and the second node ND₂) to flow through the light emitting part ELP via the drive transistor TR_{D}. Thereby, the light emitting part ELP is driven to emit light.

### [Difference Due to Configuration of Drive Circuit]

The difference among the 5Tr/1C type, the 4Tr/1C type, the 3Tr/1C type, and the 2Tr/1C type, which are each a typical configuration, is as follows. In the 5Tr/1C type, a first transistor TR₁ (emission control transistor) connected between the main electrode terminal of the drive transistor TR_{D} on the power supply side and a power supply circuit (power supply section), a second transistor TR₂ to apply the second node initialization voltage, and a third transistor TR₃ to apply the first node initialization voltage are provided. Each of the first transistor TR₁, the second transistor TR₂, and the third transistor TR₃ is a switching transistor. The first transistor TR₁ is set to the on-state in the emission period. Then it is turned to the off-state and the non-emission period starts. Thereafter, it is turned to the on-state once in the threshold correction period and is set to the on-state in the mobility correction period and the subsequent period (the next emission period, too). The second transistor TR₂ is set to the on-state only in the initialization period of the second node and is set to the off-state in the other period. The third transistor TR₃ is set to the on-state only in the period from the initialization period of the first node to the threshold correction period and is set to the off-state in the other period. The write transistor TR_{W} is set to the on-state in the period from the video signal writing processing period to the mobility correction processing period and is set to the off-state in the other period.

In the 4Tr/1C type, the third transistor TR₃ to apply the first node initialization voltage is omitted from the 5Tr/1C type and the first node initialization voltage is supplied from the video signal line DTL based on time sharing with the video signal V_{sig}. To supply the first node initialization voltage from the video signal line DTL to the first node in the initialization period of the first node, the write transistor TR_{W} is set to the on-state also in the initialization period of the first node. Typically the write transistor TR_{W} is set to the on-state in the period from the initialization period of the first node to the mobility correction processing period and is set to the off-state in the other period.

In the 3Tr/1C type, the second transistor TR₂ and the third transistor TR₂ are omitted from the 5Tr/1C type and the first node initialization voltage and the second node initialization voltage are supplied from the video signal line DTL based on time sharing with the video signal V_{sig}. As the potential of the video signal line DTL, a voltage V_{ofs}_{_{—}}_{H} corresponding to the second node initialization voltage is supplied and thereafter the first node initialization voltage V_{ofs}_{_{—}}_{L} (=V_{ofs}) is set in order to set the second node to the second node initialization voltage in the initialization period of the second node and set the first node to the first node initialization voltage in the subsequent initialization period of the first node. Furthermore, in association with this, the write transistor TR_{W} is set to the on-state also in the initialization period of the first node and the initialization period of the second node. Typically, the write transistor TR_{W} is set to the on-state in the period from the initialization period of the second node to the mobility correction processing period and is set to the off-state in the other period.

Incidentally, in the 3Tr/1C type, the potential of the second node ND₂ is changed by utilizing the video signal line DTL. Thus, the hold capacitance C_{cs} is set to a value higher than that in the other drive circuits in design (e.g. about ¼ to ⅓ of the capacitance Cₑₗ). Therefore, the point that the degree of potential change of the second node ND₂ arising due to potential change of the first node ND₁ is higher than that in the other drive circuits is taken into consideration.

In the 2Tr/1C type, the first transistor TR₁, the second transistor TR₂, and the third transistor TR₃ are omitted from the 5Tr/1C type. The first node initialization voltage is supplied from the video signal line DTL based on time sharing with the video signal V_{sig}. The second node initialization voltage is given by pulse driving of the main electrode terminal of the drive transistor TR_{D} on the power supply side with a first potential V_{cc}_{_{—}}_{H} (=V_{cc} in the 5Tr/1C type) and a second potential V_{cc}_{_{—}}_{H} (=Vᵢₙᵢ in the 5Tr/1C type). The main electrode terminal of the drive transistor TR_{D} on the power supply side is set to the first potential V_{cc}_{_{—}}_{H} in the emission period. Then, it is turned to the second potential V_{cc}_{_{—}}_{L} and thereby the non-emission period starts. Thereafter, it is set to the first potential V_{cc}_{_{—}}_{H} in the threshold correction period and the subsequent period (the next emission period, too). To supply the first node initialization voltage from the video signal line DTL to the first node in the initialization period of the first node, the write transistor TR_{W} is set to the on-state also in the initialization period of the first node. Typically, the write transistor TR_{W} is set to the on-state in the period from the initialization period of the first node to the mobility correction processing period and is set to the off-state in the other period.

In the cases explained above, correction processing is executed for both of the threshold voltage and the mobility as characteristic variation of the drive transistor. However, it is also possible to execute the correction processing for only one of them.

Although explanation is made above based on preferred examples, the technique of the present disclosure is not limited to these examples. The configurations and structures of various kinds of constituent elements configuring the display device, the display element, and the drive circuit and the steps in the driving method of the light emitting part, described in the respective examples, are examples and can be accordingly changed.

In the operation of the 5Tr/1C type, the 4Tr/1C type, and the 3Tr/1C type, the writing processing and the mobility correction may be executed separately from each other. Alternatively, the mobility correction processing may be executed in conjunction with the writing processing similarly to the 2Tr/1C type. Specifically, in the state in which the first transistor TR₁ (emission control transistor) is set to the on-state, the video signal V_{sig} is applied from the data line DTL to the first node via the write transistor TR_{W}.

### Specific Application Examples

Specific application examples of the technique to suppress the display unevenness phenomenon attributed to turning-on of the electro-optical element will be described below. In addition, in a display device using an active matrix organic EL panel, for example, various kinds of gate signals (control pulses) to be supplied to the control input terminal of a transistor are made by a vertical scanner disposed on both sides or a single side of the panel and the signals are applied to the pixel circuits 10. Furthermore, in such a display device using an organic EL panel, the pixel circuit 10 of the 2Tr/1C type is often used for reduction in the number of elements and enhancement in the definition. In view of this point, examples of application to a configuration of the 2Tr/1C type will be described below as representative examples.

### Embodiment Example 1

### Pixel Circuit

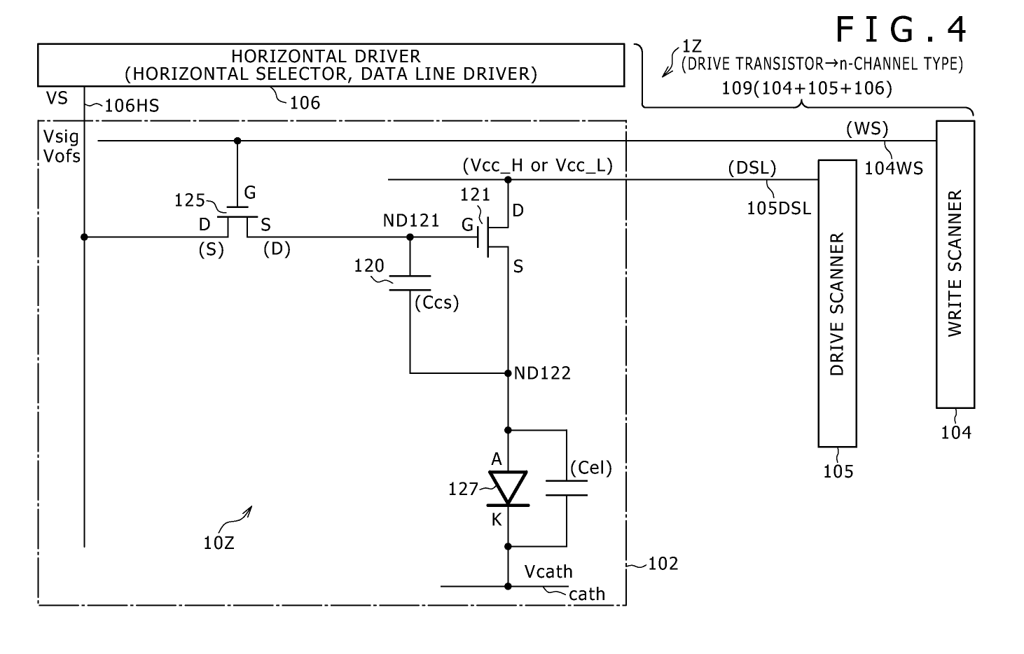

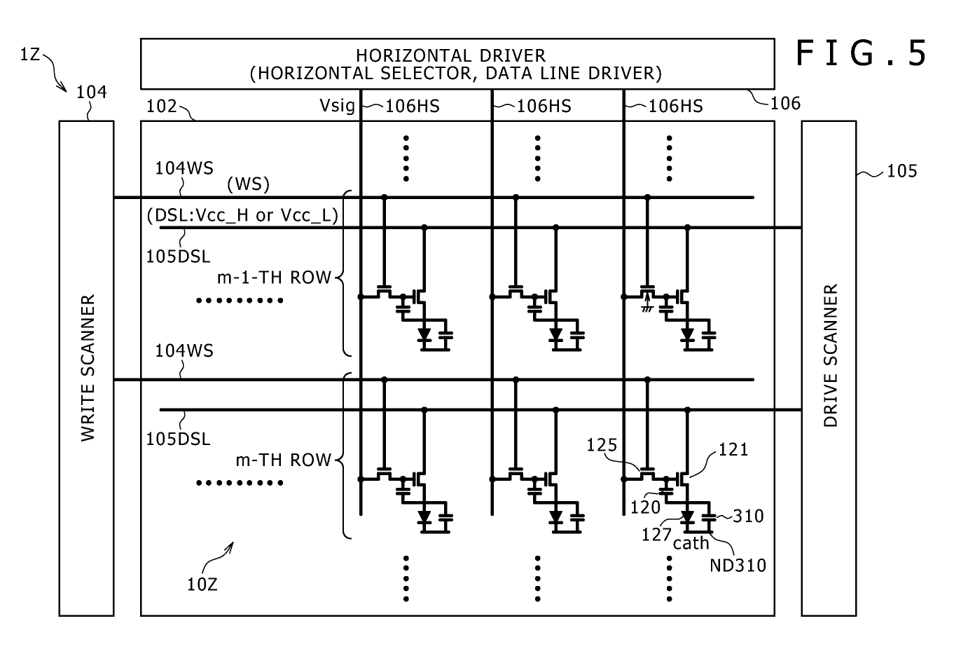

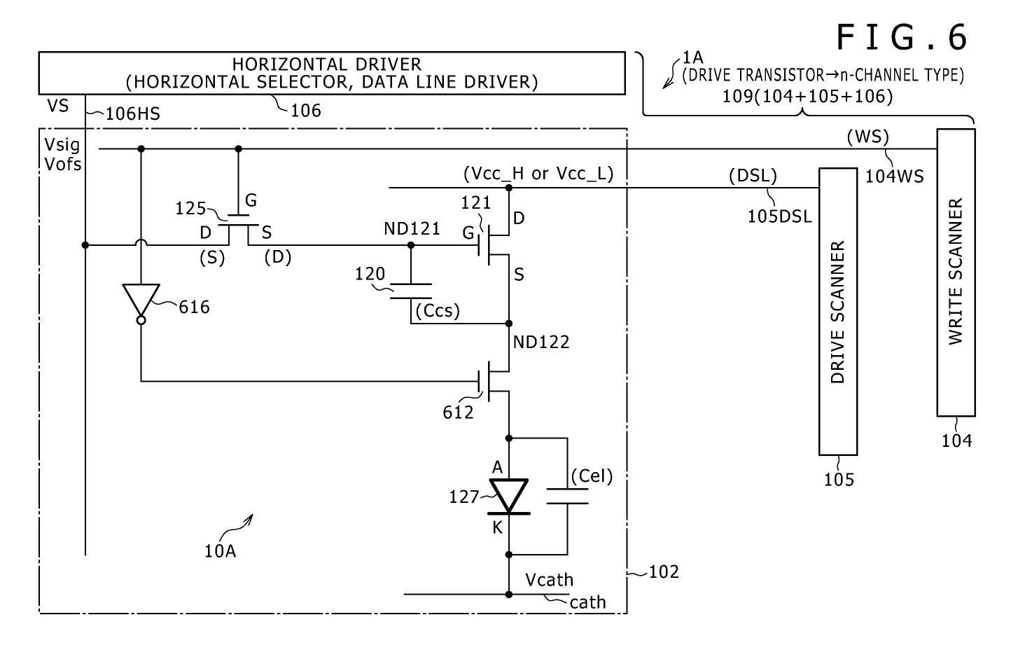

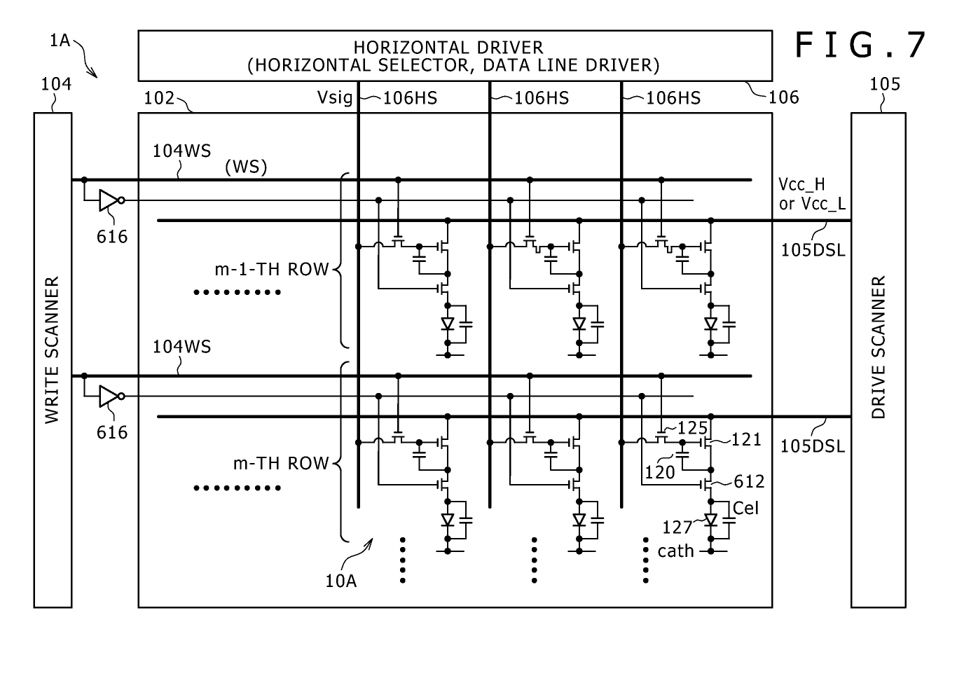

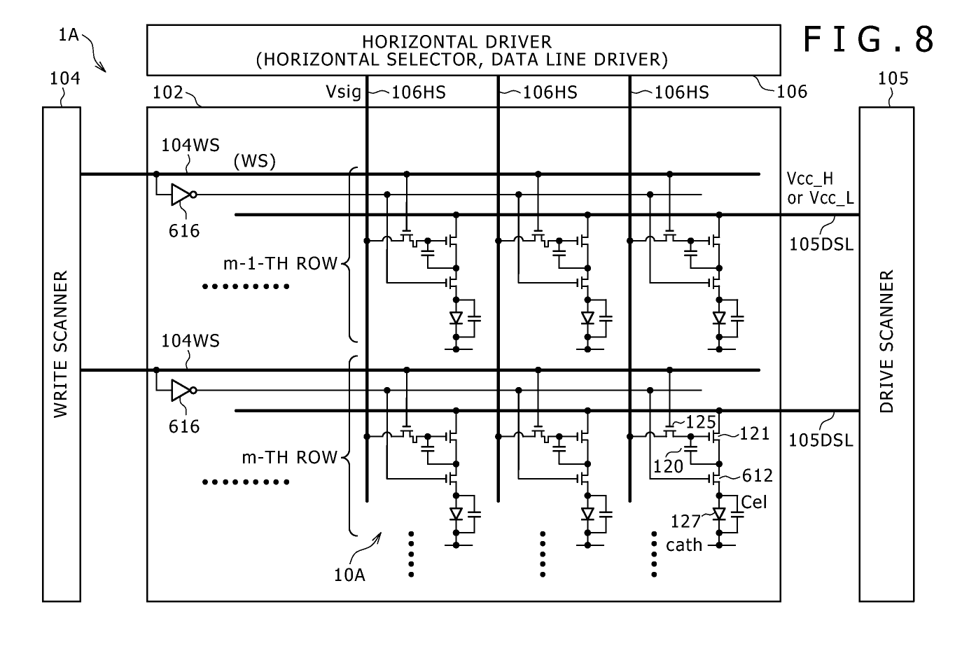

FIG. 4 and FIG. 5 are diagrams showing a pixel circuit 10Z of a comparative example against the respective embodiment examples and one form of a display device including this pixel circuit 10Z. The display device including the pixel circuit 10Z of the comparative example in the pixel array section 102 will be referred to as a display device 1Z of the comparative example. FIG. 4 shows the basic configuration (one pixel) and FIG. 5 shows the specific configuration (whole display device). FIG. 6 to FIG. 8 are diagrams showing a pixel circuit 10A of embodiment example 1 and one form of a display device including this pixel circuit 10A. The display device including the pixel circuit 10A of embodiment example 1 in the pixel array section 102 will be referred to as a display device 1A of embodiment example 1. FIG. 6 shows the basic configuration (one pixel) and FIG. 7 and FIG. 8 show the specific configuration (whole display device). In both of the comparative example and embodiment example 1, the vertical driver 103 and the horizontal driver 106 provided at the peripheral part of the pixel circuit 10 over the substrate 101 of the display panel block 100 are also shown. This applies also to other embodiment examples to be described later.

First, the part common to the comparative example and embodiment example 1 will be described with omission of reference element A and reference element Z. The display device 1 makes an electro-optical element (in the present example, an organic EL element 127 is used as the light emitting part ELP) in the pixel circuit 10 emit light based on the video signal V_{sig} (specifically signal amplitude Vᵢₙ). For this purpose, the display device 1 includes at least the following elements in the pixel circuits 10 disposed in a matrix manner in the pixel array section 102: a drive transistor 121 (drive transistor TR_{D}) to generate a drive current; hold capacitance 120 (hold capacitance C_{cs}) connected between the control input terminal (gate terminal is a typical example) and output terminal (source terminal is a typical example) of the drive transistor 121; the organic EL element 127 (light emitting part ELP) as one example of the electro-optical element connected to the output terminal of the drive transistor 121; and a sampling transistor 125 (write transistor TR_{W}) to write information corresponding to the signal amplitude Vᵢₙ to the hold capacitance 120. In this pixel circuit 10, a drive current I_{ds} based on the information held in the hold capacitance 120 is generated by the drive transistor 121 to be applied to the organic EL element 127 as one example of the electro-optical element to thereby make the organic EL element 127 emit light.

The information corresponding to the signal amplitude Vᵢₙ is written to the hold capacitance 120 by the sampling transistor 125. Thus, the sampling transistor 125 takes the signal potential (V_{ofs}+Vᵢₙ) into its input terminal (one of source terminal and drain terminal) and writes the information corresponding to the signal amplitude Vᵢₙ to the hold capacitance 120 connected to its output terminal (the other of source terminal and drain terminal). Of course, the output terminal of the sampling transistor 125 is connected also to the control input terminal of the drive transistor 121.

The connection configuration of the pixel circuit 10 shown here is the most basic configuration. As long as the pixel circuit 10 includes at least the above-described respective constituent elements, it may include elements other than these constituent elements (i.e. other constituent elements). Furthermore, “connection” is not limited to direct connection and may be connection with the intermediary of another constituent element. For example, a change such as interposition of e.g. a transistor for switching or a functional part having a certain function is often further added to the connection part according to need. Typically, to dynamically control the display period (in other words, non-emission period), a transistor for switching is often disposed between the output terminal of the drive transistor 121 and the electro-optical element (organic EL element 127) or between the power supply terminal (drain terminal is a typical example) of the drive transistor 121 and a power supply line PWL (in the present example, power supply line 105DSL) as wiring for power supply. Even a pixel circuit of such a modified form is also the pixel circuit 10 to realize the display device according to one embodiment of the present disclosure as long as it can realize the configuration and operation explained in embodiment example 1 (or another embodiment example).

At the peripheral part for driving the pixel circuit 10, e.g. the control section 109 including the write scanner 104 and the drive scanner 105 is provided. The write scanner 104 sequentially controls the sampling transistor 125 with the horizontal cycle to thereby line-sequentially scan the pixel circuits 10, and writes the information corresponding to the signal amplitude Vᵢₙ of the video signal V_{sig} to the respective hold capacitances 120 on one row. The drive scanner 105 outputs a scan drive pulse (power supply drive pulse DSL) for controlling the supply of power to be applied to the power supply terminals of the respective drive transistors 121 on one row in association with the line-sequential scanning by the write scanner 104. Furthermore, the horizontal driver 106 is provided in the control section 109. The horizontal driver 106 carries out control so that the video signal V_{sig} switched between the reference potential (V_{ofs}) and the signal potential (V_{ofs}+Vᵢₙ) in each horizontal cycle may be supplied to the sampling transistor 125 in association with the line-sequential scanning by the write scanner 104.

Preferably, the control section 109 stops the supply of the video signal V_{sig} to the control input terminal of the drive transistor 121 by turning the sampling transistor 125 to the non-conductive state at the timing when the information corresponding to the signal amplitude Vᵢₙ is written to the hold capacitance 120, to carry out control so that bootstrap operation in which the potential of the control input terminal of the drive transistor 121 changes in conjunction with potential change of the output terminal may be carried out. Preferably, the control section 109 carries out the bootstrap operation also at the initial timing of the emission start after the end of the sampling operation. Specifically, by turning the sampling transistor 125 to the non-conductive state after setting the sampling transistor 125 to the conductive state in the state in which the signal potential (V_{ofs}+Vᵢₙ) is supplied to the sampling transistor 125, the potential difference between the control input terminal and output terminal of the drive transistor 121 is kept constant.

Furthermore, preferably the control section 109 controls the bootstrap operation in such a manner as to realize aging change correction operation of the electro-optical element (organic EL element 127) in the emission period. For this purpose, preferably the control section 109 continuously sets the sampling transistor 125 to the non-conductive state in the period in which the drive current I_{ds} based on the information held in the hold capacitance 120 flows through the electro-optical element (organic EL element 127) to thereby allow the voltage between the control input terminal and the output terminal to be kept constant to realize the aging change correction operation of the electro-optical element. By the bootstrap operation of the hold capacitance 120 in light emission, the potential difference between the control input terminal and output terminal of the drive transistor 121 is kept constant by the bootstrapped hold capacitance 120 even when the current-voltage characteristic of the organic EL element 127 changes over time. Thereby, constant emission luminance is always kept. Furthermore, preferably the control section 109 turns on the sampling transistor 125 in the time zone in which the reference potential (=first node initialization voltage V_{ofs}) is supplied to the input terminal (source terminal is a typical terminal) of the sampling transistor 125, to thereby carry out control so that threshold correction operation for holding the voltage corresponding to the threshold voltage Vₜₕ of the drive transistor 121 in the hold capacitance 120 may be carried out.

Preferably this threshold correction operation is repeatedly carried out in plural horizontal cycles preceding the writing of the information corresponding to the signal amplitude Vᵢₙ to the hold capacitance 120 according to need. This “according to need” means the case in which the voltage equivalent to the threshold voltage of the drive transistor 121 may not be sufficiently held in the hold capacitance 120 in the threshold correction period in one horizontal cycle. By carrying out the threshold correction operation plural times, the voltage equivalent to the threshold voltage Vₜₕ of the drive transistor 121 is surely held in the hold capacitance 120.

Furthermore, more preferably, prior to the threshold correction operation, the control section 109 turns on the sampling transistor 125 in the time zone in which the reference potential (V_{ofs}) is supplied to the input terminal of the sampling transistor 125, to carry out control so that preparation operation (discharge operation and initialization operation) for threshold correction may be carried out. The potentials of the control input terminal and output terminal of the drive transistor 121 are initialized before the threshold correction operation. More specifically, by connecting the hold capacitance 120 between the control input terminal and the output terminal, setting is so made that the potential difference across the hold capacitance 120 becomes equal to or higher than the threshold voltage Vₜₕ.

For threshold correction in the 2Tr/1C drive configuration, the following scheme is preferable. Specifically, the control section 109 includes the drive scanner 105 that outputs the first potential V_{cc}_{_{—}}_{H} used for making the drive current I_{ds} flow through the electro-optical element (organic EL element 127) and the second potential V_{cc}_{_{—}}_{L}, different from the first potential V_{cc}_{_{—}}_{H} with switching therebetween to the respective pixel circuits 10 on one row in association with the line-sequential scanning by the write scanner 104. In addition, the sampling transistor 125 is turned on in the time zone in which the voltage corresponding to the first potential V_{cc}_{_{—}}_{H} is supplied to the power supply terminal of the drive transistor 121 and the signal potential (V_{ofs}+Vᵢₙ) is supplied to the sampling transistor 125, to thereby carry out control so that threshold correction operation may be carried out. Furthermore, for preparation operation of threshold correction in the 2TR drive configuration, preferably the sampling transistor 125 is turned on in the time zone in which the voltage corresponding to the second potential V_{cc}_{_{—}}_{L} (=second node initialization voltage Vᵢₙᵢ) is supplied to the power supply terminal of the drive transistor 121 and the reference potential (V_{ofs}) is supplied to the sampling transistor 125, to initialize the potential of the control input terminal of the drive transistor 121 (i.e. first node ND₁) to the reference potential (V_{ofs}) and initialize the potential of the output terminal (i.e. second node ND₂) to the second potential V_{cc}_{_{—}}_{L}.

More preferably, after the threshold correction operation, the control section 109 carries out control so that correction for the mobility μ of the drive transistor 121 may be added to the information written to the hold capacitance 120 in writing the information of the signal amplitude Vᵢₙ to the hold capacitance 120 by turning on the sampling transistor 125 in the time zone in which the voltage corresponding to the first potential V_{cc}_{_{—}}_{H} is supplied to the drive transistor 121 and the signal potential (V_{ofs}+Vᵢₙ) is supplied to the sampling transistor 125. Preferably, at this time, at predetermined timing in the time zone in which the signal potential (V_{ofs}+Vᵢₙ) is supplied to the sampling transistor 125, the sampling transistor 125 is set to the conductive state for a period shorter than this time zone. One example of the pixel circuit 10 with the 2Tr/1C drive configuration will be specifically described below.

In the pixel circuit 10, basically the drive transistor is formed of an n-channel thin film field effect transistor. Furthermore, the pixel circuit 10 has characteristics in the following points. Specifically, the pixel circuit 10 includes a circuit for suppressing change in the drive current I_{ds} to the organic EL element due to the deterioration of the organic EL element over time, i.e. a drive signal keep-constant circuit (first) that corrects change in the current-voltage characteristic of the organic EL element as one example of the electro-optical element to keep the drive current I_{ds} constant. Furthermore, the pixel circuit 10 employs a driving system that keeps the drive current I_{ds} constant by realizing threshold correction function and mobility correction function to prevent drive current change due to characteristic change (threshold voltage variation and mobility variation) of the drive transistor.

As a method for suppressing the influence given to the drive current I_{ds} due to characteristic change (e.g. variation and change in the threshold voltage, the mobility, and so forth) of the drive transistor 121, countermeasures are made by employing the drive circuit of the 2TR configuration as the drive signal keep-constant circuit (first) as it is and devising a scheme relating to the drive timings of the respective transistors (drive transistor 121 and sampling transistor 125). The pixel circuit 10 has the 2TR drive configuration and thus the number of elements and the number of interconnects are small. Therefore, enhancement in the definition is possible. In addition, sampling can be performed without the deterioration of the video signal V_{sig} and thus favorable image quality can be achieved.

Furthermore, the pixel circuit 10 has a characteristic in the connection form of the hold capacitance 120 and configures a bootstrap circuit that is one example of the drive signal keep-constant circuit (second) as a circuit to prevent drive current change due to the deterioration of the organic EL element 127 over time. The pixel circuit 10 has a characteristic in that it includes the drive signal keep-constant circuit (second) that realizes a bootstrap function to keep the drive current constant (prevent drive current change) even when the current-voltage characteristic of the organic EL element changes over time.

Field effect transistors (FETs) are used as the respective transistors typified by the drive transistor. In this case, about the drive transistor, the gate terminal is treated as the control input terminal. Furthermore, one of the source terminal and the drain terminal (in the present description, source terminal) is treated as the output terminal and the other (in the present description, drain terminal) is treated as the power supply terminal.

Specifically, as shown in FIG. 4 and FIG. 5, the pixel circuit 10 has the drive transistor 121 and the sampling transistor 125 that are each an n-channel type, and the organic EL element 127 as one example of the electro-optical element that emits light through current flowing. In general, the organic EL element 127 has the rectification characteristic and therefore is represented by a diode symbol. The parasitic capacitance Cₑₗ exists in the organic EL element 127. In the diagram, this parasitic capacitance Cₑₗ is shown in parallel to the organic EL element 127 (diode-like component).

The drain terminal D of the drive transistor 121 is connected to the power supply line 105DSL that supplies the first potential V_{cc}_{_{—}}_{H} or the second potential V_{cc}_{_{—}}_{L}, and the source terminal S thereof is connected to the anode terminal A of the organic EL element 127 (the connecting node thereof is the second node ND₂ and defined as a node ND122). The cathode terminal K of the organic EL element 127 is connected to cathode wiring cath (potential is a cathode potential V_{cath}, e.g. GND) that supplies a reference potential and is common to all pixel circuits 10. The cathode wiring cath may be only wiring of a single layer for it (upper-layer wiring). Alternatively, for example the resistance value of the cathode wiring may be decreased by providing auxiliary wiring for cathode wiring in the anode layer in which wiring for the anode is formed. This auxiliary wiring is wired in a lattice manner or a column or row manner in the pixel array section 102 (display area) and is at the same potential as that of the upper-layer wiring as a fixed potential.

The gate terminal G of the sampling transistor 125 is connected to a write scan line 104WS from the write scanner 104. Furthermore, the drain terminal D thereof is connected to a video signal line 106HS (video signal line DTL) and the source terminal S thereof is connected to the gate terminal G of the drive transistor 121 (the connecting node thereof is the first node ND₁ and defined as a node ND121). The active-H write drive pulse WS is supplied from the write scanner 104 to the gate terminal G of the sampling transistor 125. It is also possible for the sampling transistor 125 to have a connection form in which the source terminal S and the drain terminal D are reversed.

The drain terminal D of the drive transistor 121 is connected to the power supply line 105DSL from the drive scanner 105 that functions as a power supply scanner. The power supply line 105DSL has a characteristic in that the power supply line 105DSL itself has capability of power supply to the drive transistor 121. The drive scanner 105 supplies, to the drain terminal D of the drive transistor 121, the first potential V_{cc}_{_{—}}_{H} on the higher voltage side and the second potential V_{cc}_{_{—}}_{L} (referred to also as initialization voltage or initial voltage) that is utilized for preparation operation preceding threshold correction and is on the lower voltage side with switching therebetween. The first potential V_{cc}_{_{—}}_{H} and the second potential V_{cc}_{_{—}}_{L} are each equivalent to the power supply voltage.

Driving the side of the drain terminal D (power supply circuit side) of the drive transistor 121 by the power supply drive pulse DSL, which takes binary values of the first potential V_{cc}_{_{—}}_{H} and the second potential V_{cc}_{_{—}}_{L}, makes it possible to carry out the preparation operation preceding the threshold correction. As the second potential V_{cc}_{_{—}}_{L}, a potential sufficiently lower than the reference potential (V_{ofs}) of the video signal V_{sig} of the video signal line 106HS is employed. Specifically, the second potential V_{cc}_{_{—}}_{L} on the lower potential side of the power supply line 105DSL is so set that the gate-source voltage V_{gs} of the drive transistor 121 (difference between the gate potential V_{g} and the source potential Vₛ) becomes higher than the threshold voltage Vₜₕ of the drive transistor 121. The reference potential (V_{ofs}) is utilized for initialization operation preceding threshold correction operation and is utilized also for making the video signal line 106HS pre-charged in advance.

In such a pixel circuit 10, in driving the organic EL element 127, the first potential V_{cc}_{_{—}}_{H} is supplied to the drain terminal D of the drive transistor 121 and the source terminal S is connected to the side of the anode terminal A of the organic EL element 127. Thereby, a source follower circuit is formed as a whole.

In the case of employing such a pixel circuit 10, the 2TR drive configuration using one switching transistor (sampling transistor 125) for scanning in addition to the drive transistor 121 is employed. In addition, the on/off-timings of the power supply drive pulse DSL and the write drive pulse WS to control the respective switching transistors are designed. Thereby, the influence given to the drive current I_{ds} due to the deterioration of the organic EL element 127 over time and characteristic change of the drive transistor 121 (e.g. variation and change in the threshold voltage, the mobility, and so forth) is prevented.

### Configuration Specific to Embodiment Example 1

The pixel circuit 10A of embodiment example 1 has a configuration capable of controlling opening and closing of the current path of (light emitting part ELP of) the organic EL element 127 in association with processing of writing the drive voltage corresponding to the video signal to the hold capacitance 120. Specifically, each pixel circuit 10A has a configuration capable of blocking the electrical connection between the node ND122 (second node) and the anode terminal A of the organic EL element 127 (one terminal of the electro-optical element) in a “certain period corresponding to mobility correction.” For example, as shown in FIG. 6 and FIG. 7, a current path control transistor 612 is connected in series between the source terminal of the drive transistor 121 (ND122: second node) and one terminal of the organic EL element 127 (anode terminal A in the diagram). Here, an n-channel transistor is used as the current path control transistor 612 and the control input terminal (gate terminal) thereof is supplied with a control pulse NDS obtained by logical inversion of the write drive pulse WS.

Various configurations can be employed as the configuration to make logical inversion of the write drive pulse WS and supply the inverted pulse to the gate terminal of the current path control transistor 612. Here, as shown in FIG. 7 and FIG. 8, a configuration in which an inverter 616 is provided on a row-by-row basis at the input terminal of the pixel array section 102 is employed. In other words, because the write drive pulse WS is supplied in common to the respective sampling transistors 125 on the same row, taking this point into account, the write drive pulse WS is inverted by the inverter 616 on a row-by-row basis to generate the control pulse NDS and the control pulse NDS is supplied in common to the current path control transistors 612 on the same row via a current path control scan line 612DS. The current path control transistor 612 and the inverter 616 configure a control section that carries out blocking control of the current path of the display part in association with processing of supplying a current to the hold capacitance via the drive transistor while writing the drive voltage corresponding to the video signal to the hold capacitance. The inverter 616 of each row functions as a current path control scanner that carries out on/off-control of the current path control transistor 612.

In a first example shown in FIG. 7, the inverter 616 is provided outside the pixel array section 102. However, the inverter 616 may be provided inside the pixel array section 102 like in a second example shown in FIG. 8. In any case, the configuration is not limited to the configuration shown in the diagram as long as it is a configuration in which the inverter 616 to make logical inversion of the write drive pulse WS is provided on a row-by-row basis. For example, in the case of employing a configuration in which the write scanner 104 is disposed on both sides of the pixel array section 102 and the write drive pulse WS is supplied from both sides (in this case, assigned part is divided at substantially the center of the pixel array section 102), a configuration in which the inverter 616 is also disposed on both sides of the pixel array section 102 is employed. Although not shown in the diagram, it is also possible to employ a configuration in which the inverter 616 is provided for each pixel circuit 10A (whether it is provided inside or outside the pixel circuit 10A is no object) and the control pulse NDS is individually generated. However, in this case, the circuit scale increases compared with the configuration of embodiment example 1 shown in FIG. 7.

In the pixel circuit 10A of embodiment example 1, when the write drive pulse WS is active-H (i.e. the sampling transistor 125 is in the on-state), the control pulse NDS is L (low level) and therefore the current path control transistor 612 is in the off-state. On the other hand, when the write drive pulse WS is inactive-L (i.e. the sampling transistor 125 is in the off-state), the control pulse NDS is H (high level) and therefore the current path control transistor 612 is in the on-state. That is, the write drive pulse WS and the control pulse NDS control the corresponding transistor in association with each other and thus the sampling transistor 125 and the current path control transistor 612 added in embodiment example 1 carry out complementary operation logically. In the period when the write drive pulse WS is at the L level (e.g. emission period), the current path control transistor 612 is in the on-state. Thus, the source terminal of the drive transistor 121 (ND122) is electrically connected to the anode terminal of the organic EL element 127 and the drive current I_{ds} from the drive transistor 121 flows to the organic EL element 127. On the other hand, in the period when the write drive pulse WS is at the H level (e.g. threshold correction period, signal writing period, and mobility correction period), the current path control transistor 612 is in the off-state. Thus, the source terminal of the drive transistor 121 (ND122) is electrically isolated from the anode terminal of the organic EL element 127 and the current from the drive transistor 121 does not flow to the organic EL element 127. That is, opening/closing control of the current path of the organic EL element 127 is carried out in association with the write drive pulse. Details of the meaning and advantages of employing the pixel circuit 10A of such embodiment example 1 will be described later. Mobility correction operation can be normally carried out by preventing turning-on of the organic EL element 127 in the mobility correction.

### [Operation of Pixel Circuit]

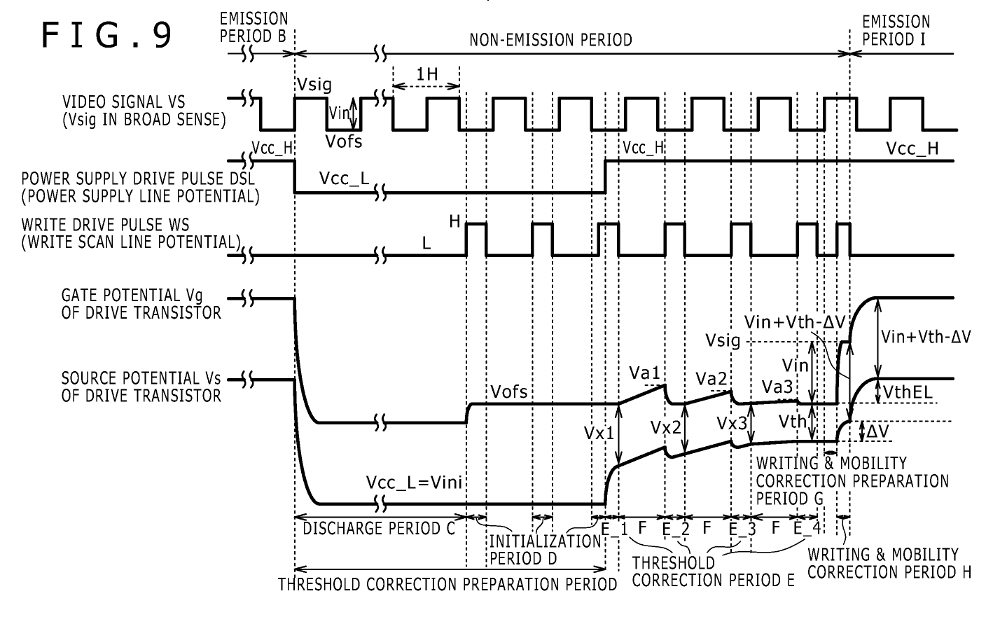

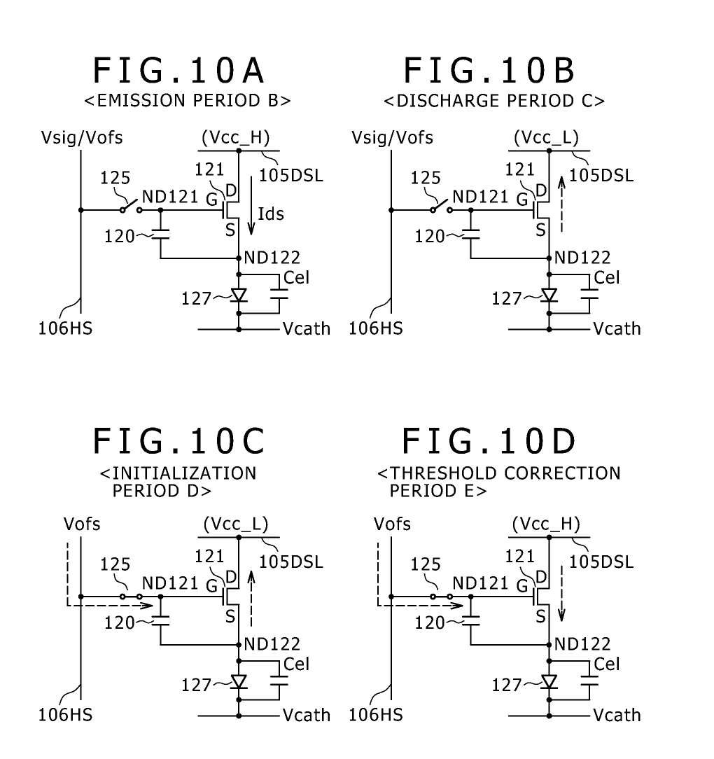

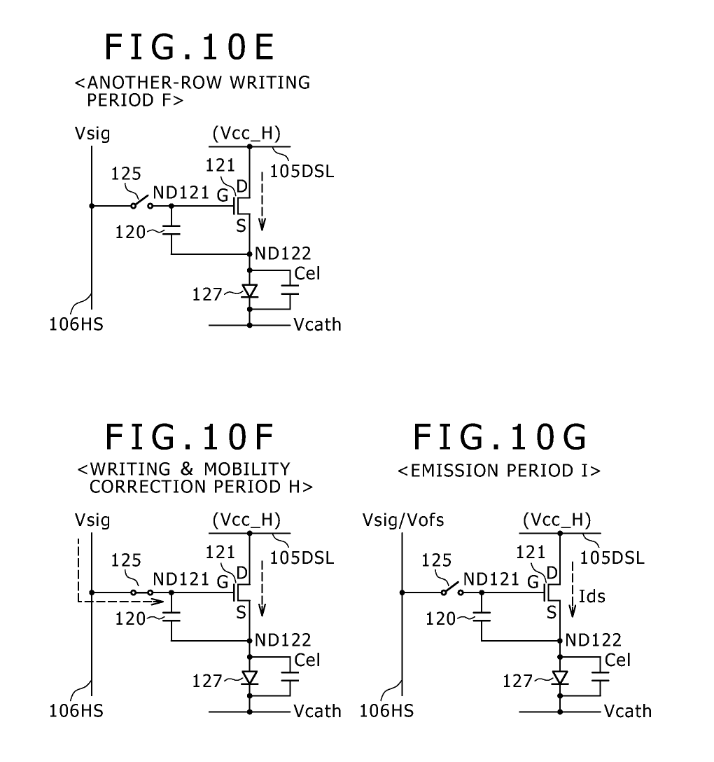

FIG. 9 is a timing chart (ideal state) for explaining operation in writing information of the signal amplitude Vᵢₙ to the hold capacitance 120 by a line-sequential system as one example of the drive timings relating to the pixel circuit 10. FIG. 10 is a diagram for explaining the equivalent circuit and the operation state in major periods in the timing chart shown in FIG. 9. In FIG. 9, along a common time axis, potential change of the write scan line 104WS, potential change of the power supply line 105DSL, and potential change of the video signal line 106HS are shown. In parallel to these potential changes, changes in the gate potential V_{g} and source potential Vₛ of the drive transistor 121 are also shown. Basically, for each one row of the write scan line 104WS and the power supply line 105DSL, similar driving is performed with delay by one horizontal scanning period. In the following, explanation will be made about the pixel circuit 10Z of the comparative example. The operation explained below is similarly applied to respects for which a particular notice is not made in the respective embodiment examples described later.

The value of the current flowing to the organic EL element 127 is controlled based on the timings of the respective pulses like the signals in FIG. 9. In the timing example of FIG. 9, the power supply drive pulse DSL is set to the second potential V_{cc}_{_{—}}_{L} to thereby stop emission and initialize the node ND122. Thereafter, the node ND121 is initialized by turning the sampling transistor 125 to the on-state when the first node initialization potential V_{ofs} is applied to the video signal line 106HS. In this state, the power supply drive pulse DSL is set to the first potential V_{cc}_{_{—}}_{H}. Thereby, threshold correction is carried out. Thereafter, the sampling transistor 125 is turned to the off-state and the video signal V_{sig} is applied to the video signal line 106HS. In this state, the sampling transistor 125 is turned to the on-state. Thereby, the signal is written and simultaneously mobility correction is carried out. After the signal is written, the sampling transistor 125 is turned to the off-state. Thereupon, light emission is started. In this manner, driving for the mobility correction, the threshold correction, and so forth is controlled based on the phase difference among the pulses.

The operation will be described in detail below with focus on the threshold correction and the mobility correction. As the drive timings in the pixel circuit 10, first, the sampling transistor 125 is turned on in response to the write drive pulse WS supplied from the write scan line 104WS and performs sampling of the video signal V_{sig} supplied from the video signal line 106HS to hold it in the hold capacitance 120. First, in the following description, to facilitate explanation and understanding, it is assumed that the writing gain is 1 (ideal value) unless there is a particular notice. In addition, brief expression will be made as follows. Specifically, information of the signal amplitude Vᵢₙ is e.g. written, held, or sampled in the hold capacitance 120. If the writing gain is lower than 1, not the magnitude of the signal amplitude Vᵢₙ itself but information multiplied by the gain corresponding to the magnitude of the signal amplitude Vᵢₙ is held in the hold capacitance 120.

As the drive timings for the pixel circuit 10, in writing information of the signal amplitude Vᵢₙ of the video signal V_{sig} to the hold capacitance 120, line-sequential driving of simultaneously transmitting the video signals for one row to the video signal lines 106HS of the respective columns is carried out in view of sequential scanning. In particular, in the basic concept in the threshold correction and the mobility correction based on the drive timings in the pixel circuit 10 with the 2TR configuration, first the video signal V_{sig} has the reference potential (V_{ofs}) and the signal potential (V_{ofs}+Vᵢₙ) in the 1H period in a time-division manner. Specifically, the period in which the video signal V_{sig} is the reference potential (V_{ofs}) as the ineffective period is regarded as the first half part of one horizontal period and the period in which the video signal V_{sig} is the signal potential (V_{sig}=V_{ofs}+Vᵢₙ) as the effective period is regarded as the second half part of one horizontal period. In dividing one horizontal period into the first half part and the second half part, typically it is divided into almost ½ periods. However, this is not essential. The second half part may be set longer than the first half part or conversely the second half part may be set shorter than the first half part.

The write drive pulse WS used for signal writing is used also for threshold correction and mobility correction, and the write drive pulse WS is set active to turn on the sampling transistor 125 two times in the 1H period. The threshold correction is carried out at the first on-timing, and the signal voltage writing and the mobility correction are simultaneously carried out at the second on-timing. Thereafter, the drive transistor 121 receives current supply from the power supply line 105DSL at the first potential (higher potential side) and makes the drive current I_{ds} flow to the organic EL element 127 depending on the signal potential (potential corresponding to the potential of the effective period of the video signal V_{sig}) held in the hold capacitance 120. Instead of setting the write drive pulse WS active two times in the 1H period, the potential of the video signal line 106HS may be set to the signal potential (=V_{ofs}+Vᵢₙ) for controlling the luminance in the organic EL element 127 with the on-state of the sampling transistor 125 kept.

For example, in the emission state of the organic EL element 127, the power supply line 105DSL is at the first potential V_{cc}_{_{—}}_{H} and the sampling transistor 125 is in the off-state (see FIG. 10A). At this time, the current I_{ds} flowing to the organic EL element 127 has the value shown by expression (1), determined depending on the gate-source voltage V_{gs} of the drive transistor 121 (voltage between the node ND121 and the node ND122) because the drive transistor 121 is so designed as to operate in the saturation region. Thereafter, the vertical driver 103 outputs the write drive pulse WS as the control signal to turn on the sampling transistor 125 in the time zone in which the power supply line 105DSL is at the first potential V_{cc}_{_{—}}_{H} and the video signal line 106HS is at the reference potential (V_{ofs}) corresponding to the ineffective period of the video signal V_{sig}. Thereby, the vertical driver 103 holds the voltage equivalent to the threshold voltage Vₜₕ of the drive transistor 121 in the hold capacitance 120 (see FIG. 10D). This operation realizes the threshold correction function. By this threshold correction function, the influence of the threshold voltage Vₜₕ of the drive transistor 121 varying on each pixel circuit 10 basis can be cancelled.

It is preferable for the vertical driver 103 to surely hold the voltage equivalent to the threshold voltage Vₜₕ of the drive transistor 121 in the hold capacitance 120 by repeatedly carrying out the threshold correction operation in plural horizontal periods preceding the sampling of the signal amplitude Vᵢₙ. By carrying out the threshold correction operation plural times, a sufficiently-long writing time is ensured. This makes it possible to surely hold the voltage equivalent to the threshold voltage Vₜₕ of the drive transistor 121 in the hold capacitance 120 in advance.

The held voltage equivalent to the threshold voltage Vₜₕ is used for cancel of the threshold voltage Vₜₕ of the drive transistor 121. Therefore, even when the threshold voltage Vₜₕ of the drive transistor 121 varies on each pixel circuit 10 basis, the image uniformity, i.e. the evenness of the emission luminance across the whole screen of the display device, is enhanced because the threshold voltage Vₜₕ is completely cancelled on each pixel circuit 10 basis. In particular, luminance unevenness, which tends to appear when the signal potential is a low-grayscale potential, can be prevented.

Preferably, prior to the threshold correction operation, the vertical driver 103 sets the write drive pulse WS active (in the present example, H level) to turn on the sampling transistor 125 in the time zone in which the power supply line 105DSL is at the second potential and the video signal line 106HS is at the reference potential (V_{ofs}) corresponding to the ineffective period of the video signal V_{sig}. Thereafter, the vertical driver 103 sets the power supply line 105DSL to the first potential with the write drive pulse WS kept active-H.

Due to this, after the source terminal S is set to the second potential V_{cc}_{_{—}}_{L} sufficiently lower than the reference potential (V_{ofs}) (discharge period C=second node initialization period) (see FIG. 10B) and the gate terminal G of the drive transistor 121 is set to the reference potential (V_{ofs}) (initialization period D=first node initialization period) (see FIG. 10C), the threshold correction operation is started (threshold correction period E). By such reset operation (initialization operation) of the gate potential and the source potential, the subsequent threshold correction operation can be surely carried out. Discharge period C and initialization period D are collectively referred to also as the threshold correction preparation period (=pre-processing period) for initializing the gate potential V_{g} and the source potential Vₛ of the drive transistor 121. Incidentally, in the example shown in the diagram, the initialization operation for the node ND121 as the first node (initialization period D) is repeated three times and the period from the start of discharge period C to the completion of the last initialization period D serves as the threshold correction preparation period.

In threshold correction period E, the potential of the power supply line 105DSL transitions from the second potential V_{cc}_{_{—}}_{L} on the lower potential side to the first potential V_{cc}_{_{—}}_{H} on the higher potential side, and thereby the source potential V, of the drive transistor 121 starts to rise. Specifically, the gate terminal G of the drive transistor 121 is kept at the reference potential (V_{ofs}) of the video signal V_{sig}, and the drain current seeks to flow until the drive transistor 121 is cut off due to the rise of the potential Vₛ of the source terminal S of the drive transistor 121. When the drive transistor 121 is cut off, the source potential Vₛ of the drive transistor 121 is “V_{ofs}−Vₜₕ.” The potential V_{cath} of the ground wiring cath common to all pixels is so set that, in threshold correction period E, the organic EL element 127 is kept at the cut-off state so that the drain current may flow exclusively to the side of the hold capacitance 120 (when C_{cs}<<Cₑₗ) and be prevented from flowing to the side of the organic EL element 127.

The equivalent circuit of the organic EL element 127 is represented by a parallel circuit of a diode and the parasitic capacitance Cₑₗ. Therefore, the drain current I_{ds} of the drive transistor 121 is used to charge the hold capacitance 120 and the parasitic capacitance Cₑₗ as long as “Vₑₗ≦V_{cath}+V_{thEL}” is satisfied, i.e. as long as the leakage current of the organic EL element 127 is considerably smaller than the current flowing through the drive transistor 121. As a result, the voltage Vₑₗ of the anode terminal A of the organic EL element 127, i.e. the potential of the node ND122, rises up over time. Then, at the timing when the potential difference between the potential of the node ND122 (source potential Vₛ) and the potential of the node ND121 (gate potential V_{g}) becomes just the threshold voltage Vₜₕ, the drive transistor 121 is turned from the on-state to the off-state. Thus, the flowing of the drain current I_{ds} stops and the threshold correction period ends. That is, after the elapse of a certain time, the gate-source voltage V_{gs} of the drive transistor 121 takes a value of the threshold voltage Vₜₕ.

It is also possible to carry out the threshold correction operation only one time. However, this is not essential. The threshold correction operation may be repeated plural times (four times, in the diagram) in such a manner that one horizontal period is the processing cycle. For example, actually the voltage equivalent to the threshold voltage Vₜₕ is written to the hold capacitance 120 connected between the gate terminal G and source terminal S of the drive transistor 121. However, threshold correction period E is from the timing when the write drive pulse WS is set active-H to the timing when it is returned to inactive-L. If this period is not sufficiently ensured, the threshold correction period ends before the writing of the voltage equivalent to the threshold voltage Vₜₕ. To solve this problem, repeating the threshold correction operation plural times is preferable.

The reason why one horizontal period is the processing cycle of the threshold correction operation in the case of carrying out the threshold correction operation plural times is as follows. Specifically, prior to the threshold correction operation, the process goes through initialization operation, in which the reference potential (V_{ofs}) is supplied via the video signal line 106HS to set the source potential to the second potential V_{cc}_{_{—}}_{L} in the first half part of one horizontal period. Naturally, the threshold correction period is shorter than one horizontal period. This possibly causes the case in which the accurate voltage corresponding to the threshold voltage Vₜₕ cannot be held in the hold capacitance 120 in one round of this short threshold correction operation period due to the magnitude relationship between the capacitance C_{cs} of the hold capacitance 120 and the second potential V_{cc}_{_{—}}_{L} and other factors. The reason why it is preferable to carry out the threshold correction operation plural times is because the plural times of the threshold correction operation serve as a countermeasure against this problem. Specifically, it is preferable to surely hold the voltage equivalent to the threshold voltage Vₜₕ of the drive transistor 121 in the hold capacitance 120 by repeatedly carrying out the threshold correction operation in plural horizontal cycles preceding sampling of the signal amplitude Vᵢₙ to the hold capacitance 120 (signal writing).

For example, first threshold correction period E_1 ends when the gate-source voltage V_{gs} becomes Vₓ₁ (>Vₜₕ), i.e. when the source potential Vₛ of the drive transistor 121 becomes “V_{ofs}−Vₓ₁” from the second potential V_{cc}_{_{—}}_{L} on the lower potential side (see FIG. 10D). Thus, Vₓ₁ is written to the hold capacitance 120 at the timing of the completion of first threshold correction period E_1.

Next, in the second half part of one horizontal period, the drive scanner 105 switches the write drive pulse WS to inactive-L and the horizontal driver 106 switches the potential of the video signal line 106HS from the reference potential (V_{ofs}) to the video signal V_{sig} (=V_{ofs}+Vᵢₙ) (see FIG. 10E). Due to this, the potential of the video signal line 106HS changes to the potential of the video signal V_{sig} and the potential of the write scan line 104WS (write drive pulse WS) becomes the low level.

At this time, the sampling transistor 125 is in the non-conductive (off) state. The drain current depending on Vₓ₁ held in the hold capacitance 120 before the switching of the sampling transistor 125 flows to the organic EL element 127. Thereby, the source potential Vₛ slightly rises up. If the amount of this rise is defined as Vₐ₁, the source potential Vₛ becomes “V_{ofs}−Vₓ₁+Vₐ₁.” Furthermore, the hold capacitance 120 is connected between the gate terminal G and source terminal S of the drive transistor 121. Due to the effect by this hold capacitance 120, the gate potential V_{g} changes in association with change in the source potential Vₛ of the drive transistor 121. Thereby, the gate potential V_{g} becomes “V_{ofs}+Vₐ₁.”

In the next second threshold correction period E_2, the same operation as that in first threshold correction period E_1 is carried out. Specifically, first, the gate terminal G of the drive transistor 121 is held at the reference potential (V_{ofs}) of the video signal V_{sig} and the gate potential V_{g} is instantaneously switched from the immediately previous “V_{g}=reference potential (V_{ofs})+Vₐ₁” to the reference potential (V_{ofs}). The hold capacitance 120 is connected between the gate terminal G and source terminal S of the drive transistor 121. Due to the effect by this hold capacitance 120, the source potential Vₛ changes in association with change in the gate potential V_{g} of the drive transistor 121. Thereby, the source potential Vₛ is lowered by Vₐ₁ from the immediately previous “V_{ofs}−Vₓ₁+Vₐ₁” and thus becomes “V_{ofs}−Vₓ₁.” Thereafter, the drain current seeks to flow until the drive transistor 121 is cut off due to the rise of the potential Vₛ of the source terminal S of the drive transistor 121. However, this potential rise ends when the gate-source voltage Vₐₛ becomes Vₓ₂ (>Vₜₕ), i.e. when the source potential Vₛ of the drive transistor 121 becomes “V_{ofs}−Vₓ₂,” and Vₓ₂ is written to the hold capacitance 120 at the timing of the completion of second threshold correction period E_2. Immediately before the next third threshold correction period E_3, due to the flowing of the drain current depending on Vₓ₂ held in the hold capacitance 120 to the organic EL element 127, the source potential Vₛ becomes “V_{ofs}−Vₓ₂+Vₐ₂” and the gate potential V_{g} becomes “V_{ofs}+Vₐ₂.”

Similarly, in the next third threshold correction period E_3, the source potential rise ends when the gate-source voltage V_{gs} becomes Vₓ₃ (>Vₜₕ), i.e. when the source potential Vₛ of the drive transistor 121 becomes “V_{ofs}−Vₓ₃,” and Vₓ₃ is written to the hold capacitance 120 at the timing of the completion of third threshold correction period E_3. Immediately before the next fourth threshold correction period E_4, due to the flowing of the drain current depending on Vₓ₃ held in the hold capacitance 120 to the organic EL element 127, the source potential Vₛ becomes “V_{ofs}−Vₓ₃+Vₐ₃” and the gate potential V_{g} becomes “V_{ofs}+Vₐ₃.”

Then, in the next fourth threshold correction period E_4, the drain current flows until the drive transistor 121 is cut off due to the rise of the potential Vₛ of the source terminal S of the drive transistor 121. When the drive transistor 121 is cut off, the source potential Vₛ of the drive transistor 121 is “V_{ofs}−Vₜₕ” and the state in which the gate-source voltage V_{gs} is equal to the threshold voltage Vₜₕ is obtained. At the timing of the completion of fourth threshold correction period E_4, the threshold voltage Vₜₕ of the drive transistor 121 is held in the hold capacitance 120.

The pixel circuit 10 has the mobility correction function in addition to the threshold correction function. Specifically, in order to turn the sampling transistor 125 to the conductive state in the time zone in which the video signal line 106HS is at the signal potential (V_{ofs}+Vᵢₙ) corresponding to the effective period of the video signal V_{sig}, the vertical driver 103 keeps the write drive pulse WS supplied to the write scan line 104WS active (in the present example, H level) for a period shorter than the above-described time zone. In this period, the parasitic capacitance Cₑₗ of the organic EL element 127 and the hold capacitance 120 are charged via the drive transistor 121 in the state in which the signal potential (V_{ofs}+Vᵢₙ) is supplied to the control input terminal of the drive transistor 121 (see FIG. 10F). By properly setting this active period of the write drive pulse WS (this period is both sampling period and mobility correction period), correction for the mobility μ of the drive transistor 121 can be added simultaneously with holding of information corresponding to the signal amplitude Vᵢₙ in the hold capacitance 120. The period in which the signal potential (V_{ofs}+Vᵢₙ) is actually supplied to the video signal line 106HS by the horizontal driver 106 and the write drive pulse WS is set to the active-H is referred to as the writing period of the signal amplitude Vᵢₙ to the hold capacitance 120 (referred to also as the sampling period).

In particular, in the drive timings in the pixel circuit 10, the write drive pulse WS is set active in the time zone in which the power supply line 105DSL is at the first potential V_{cc}_{_{—}}_{H} on the higher potential side and the video signal V_{sig} is in the effective period (period of the signal amplitude Vᵢₙ). That is, as a result, the mobility correction time (and sampling period) is determined by the range of overlapping between the width of the time in which the potential of the video signal line 106HS is at the signal potential (V_{ofs}+Vᵢₙ) corresponding to the effective period of the video signal V_{sig} and the active period of the write drive pulse WS. In particular, because the width of the active period of the write drive pulse WS is set somewhat small so as to fall within the width of the time in which the video signal line 106HS is at the signal potential, the mobility correction time is determined by the write drive pulse WS consequently. To be exact, the mobility correction time (and sampling period) is the time from the timing when the write drive pulse WS rises up and the sampling transistor 125 is turned on to the timing when the write drive pulse WS falls down and the sampling transistor 125 is turned off. In the diagram, the write drive pulse WS is temporarily set inactive-L after fourth threshold correction period E_4. However, this is not essential. The video signal V_{sig} may be switched from the reference potential (V_{ofs}) to the signal potential (V_{ofs}+Vᵢₙ) corresponding to the effective period, with the write drive pulse WS kept active-H.

Specifically, in the sampling period, the sampling transistor 125 becomes the conductive (on) state in the state in which the gate potential V_{g} of the drive transistor 121 is the signal potential (V_{ofs}+Vᵢₙ). Therefore, in writing & mobility correction period H, the drive current I_{ds} flows through the drive transistor 121 in the state in which the gate terminal G of the drive transistor 121 is fixed to the signal potential (V_{ofs}+Vᵢₙ). The information of the signal amplitude Vᵢₙ is so held as to be added to the threshold voltage Vₜₕ of the drive transistor 121. As a result, change in the threshold voltage Vₜₕ of the drive transistor 121 is always canceled, which is equivalent to threshold correction. By this threshold correction, the gate-source voltage V_{gs} held in the hold capacitance 120 becomes “V_{sig}+Vₜₕ”=“Vᵢₙ+Vₜₕ.” Furthermore, because the mobility correction is simultaneously carried out in this sampling period, the sampling period serves also as the mobility correction period (writing & mobility correction period H).

When the threshold voltage of the organic EL element 127 is defined as V_{thEL}, by setting a relationship of “V_{ofs}−Vₜₕ<V_{thEL},” the organic EL element 127 is set to the reverse-bias state and is in the cut-off state (high-impedance state). Thus, it does not emit light and exhibits not the diode characteristic but a simple capacitive characteristic. Thus, the drain current (drive current I_{ds}) flowing through the drive transistor 121 is written to capacitance “C=C_{cs}+Cₑₗ” resulting from coupling between the capacitance C_{cs} of the hold capacitance 120 and the parasitic capacitance (equivalent capacitance) Cₑₗ of the organic EL element 127. Due to this, the drain current of the drive transistor 121 flows to the parasitic capacitance Cₑₗ of the organic EL element 127 and starts charge. As a result, the source potential Vₛ of the drive transistor 121 rises up.

In the timing chart of FIG. 9, the amount of this potential rise is represented by ΔV. This rise amount, i.e. the potential correction value ΔV as a mobility correction parameter, is subtracted from the gate-source voltage “V_{gs}=Vᵢₙ+Vₜₕ” held in the hold capacitance 120 through threshold correction, so that the gate-source voltage becomes “V_{gs}=Vᵢₙ+Vₜₕ−ΔV.” Consequently, negative feedback is applied. At this time, the source potential V, of the drive transistor 121 becomes “−Vₜₕ ΔV,” which is the value obtained by subtracting the voltage “V_{gs}=Vᵢₙ+Vₜₕ−ΔV” held in the hold capacitance from the gate potential V_{g} (=Vᵢₙ).

In this manner, by the drive timings in the pixel circuit 10, sampling of the signal amplitude Vᵢₙ and adjustment of ΔV (negative feedback amount, mobility correction parameter) for correction of the mobility μ are carried out in writing & mobility correction period H. The write scanner 104 can adjust the time width of writing & mobility correction period H and thereby the amount of negative feedback of the drive current I_{ds} to the hold capacitance 120 can be optimized.

The potential correction value ΔV is ΔV≈I_{ds}·t/Cₑₗ. As is apparent from this equation, the potential correction value ΔV is larger when the drive current I_{ds} as the drain-source current of the drive transistor 121 is larger. Conversely, the potential correction value ΔV is smaller when the drive current I_{ds} of the drive transistor 121 is smaller. In this manner, the potential correction value ΔV is determined depending on the drive current I_{ds}. When the signal amplitude Vᵢₙ is higher, the drive current I_{ds} is larger and the absolute value of the potential correction value ΔV is also larger. Therefore, the mobility correction associated with the emission luminance level can be realized. At this time, writing & mobility correction period H does not necessarily need to be constant. On the contrary, adjusting it depending on the drive current I_{ds} is preferable in some cases. For example, it is preferable that the mobility correction period t be set somewhat short if the drive current I_{ds} is large and conversely writing & mobility correction period H be set somewhat long if the drive current I_{ds} is small.

Furthermore, the potential correction value ΔV is I_{ds}·t/Cₑₗ. Thus, even when the drive current I_{ds} varies attributed to variation in the mobility μ on each pixel circuit 10 basis, the potential correction values ΔV that are each suitable for a respective one of the values of the drive current I_{ds} are obtained. Therefore, the variation in the mobility μ on each pixel circuit 10 basis can be corrected. That is, if the signal amplitude Vᵢₙ is constant, the absolute value of the potential correction value ΔV is larger when the mobility μ of the drive transistor 121 is higher. In other words, because the potential correction value ΔV is larger when the mobility μ is higher, variation in the mobility μ on each pixel circuit 10 can be eliminated.

The pixel circuit 10 has also a bootstrap function. Specifically, at the timing when information of the signal amplitude Vᵢₙ is held in the hold capacitance 120, the write scanner 104 cancels the application of the write drive pulse WS to the write scan line 104WS (i.e. turns it to inactive-L (low)) to turn the sampling transistor 125 to the non-conductive state and electrically isolate the gate terminal G of the drive transistor 121 from the video signal line 106HS (emission period I: see FIG. 10G). After the start of emission period I, the horizontal driver 106 returns the potential of the video signal line 106HS to the reference potential (V_{ofs}) at a subsequent appropriate timing.

The emission state of the organic EL element 127 is continued until the (m+m′−1)-th horizontal scanning period. Through the above-described process, the operation of light emission of the organic EL element 127 configuring the (n, m)-th sub-pixel is completed. Thereafter, the next frame (or field) starts and the threshold correction preparation operation, the threshold correction operation, the mobility correction operation, and the emission operation are repeated again.

In emission period I, the gate terminal G of the drive transistor 121 is isolated from the video signal line 106HS. Because the application of the signal potential (V_{ofs}+Vᵢₙ) to the gate terminal G of the drive transistor 121 is canceled, the gate potential V_{g} of the drive transistor 121 is allowed to rise up. The hold capacitance 120 is connected between the gate terminal G and source terminal S of the drive transistor 121, and bootstrap operation is carried out due to the effect by this hold capacitance 120. If it is assumed that the bootstrap gain is 1 (ideal value), the source potential Vₛ changes in association with the gate potential V_{g} of the drive transistor 121 and the gate-source voltage V_{gs} can be kept constant. At this time, the drive current I_{ds} flowing through the drive transistor 121 flows to the organic EL element 127 and the anode potential of the organic EL element 127 rises up depending on the drive current I_{ds}. The amount of this potential rise is defined as Vₑₗ. In due course, the reverse-bias state of the organic EL element 127 is eliminated along with the rise of the source potential Vₛ. Thus, the organic EL element 127 actually starts light emission due to the flowing of the drive current I_{ds} thereto.

The relationship of drive current I_{ds} vs. gate voltage V_{gs} can be represented as expression (5A) or expression (5B) (both expressions are collectively referred to as expression (5)) by substituting “V_{sig}+Vₜₕ−ΔV” or “Vᵢₙ+Vₜₕ−ΔV” into the above-described expression (1) showing the transistor characteristics.

I_{ds}=k·μ·(V_{sig}−V_{ofs}−ΔV)² (5A)

I_{ds}=k·μ·(Vᵢₙ−V_{ofs}−ΔV)² (5B)

From this expression (5), it turns out that the term of the threshold voltage Vₜₕ is canceled and the drive current I_{ds} supplied to the organic EL element 127 does not depend on the threshold voltage Vₜₕ of the drive transistor 121. Specifically, for example if V_{ofs} is set to 0 volts, the current I_{ds} flowing through the organic EL element 127 is in proportion to the square of the value obtained by subtracting the potential correction value ΔV at the second node ND₂ (source terminal of the drive transistor 121) attributed to the mobility μ of the drive transistor 121 from the value of the video signal V_{sig} for controlling the luminance in the organic EL element 127. In other words, the current I_{ds} flowing through the organic EL element 127 does not depend on the threshold voltage V_{thEL} of the organic EL element 127 and the threshold voltage Vₜₕ of the drive transistor 121. That is, the emission amount (luminance) of the organic EL element 127 is not affected by the threshold voltage V_{thEL} of the organic EL element 127 and the threshold voltage Vₜₕ of the drive transistor 121. Furthermore, the luminance of the (n, m)-th organic EL element 127 has the value corresponding to the current I_{ds}.

In addition, for the drive transistor 121 having higher mobility μ, the potential correction value ΔV is larger and thus the value of the gate-source voltage V_{gs} is smaller. Therefore, in expression (5), the value of (V_{sig}−V_{ofs}−ΔV)² is small although the value of the mobility μ is large. As a result, the drain current I_{ds} can be corrected. Specifically, even in the drive transistors 121 with different mobility μ, the drain current I_{ds} is substantially the same when the value of the video signal V_{sig} is the same. As a result, the current I_{ds}, which flows through the organic EL element 127 and controls the luminance of the organic EL element 127, is made uniform. That is, variation in the luminance of the organic EL element 127 attributed to variation in the mobility μ (and variation in k) can be corrected.

Furthermore, the hold capacitance 120 is connected between the gate terminal G and source terminal S of the drive transistor 121. Due to the effect by this hold capacitance 120, bootstrap operation is carried out at the first stage of the emission period. Thereby, the gate potential V_{g} and source potential Vₛ of the drive transistor 121 rise up in such a manner that the gate-source voltage “V_{gs}=Vᵢₙ+Vₜₕ−ΔV” of the drive transistor 121 is kept constant. Because the source potential Vₛ of the drive transistor 121 becomes “−Vₜₕ+ΔV+Vₑₗ,” the gate potential V_{g} becomes “Vᵢₙ+Vₑₗ.” At this time, the gate-source voltage V_{gs} of the drive transistor 121 is constant and thus the drive transistor 121 applies a constant current (drive current I_{ds}) to the organic EL element 127. As a result, the potential of the anode terminal A of the organic EL element 127 (=potential of the node ND122) rises up to such a voltage that the drive current I_{ds} in the saturation state can flow to the organic EL element 127.

The I-V characteristic of the organic EL element 127 changes along with increase in the emission time. Thus, the potential of the node ND122 also changes along with time elapse. However, even when the anode potential of the organic EL element 127 changes due to this deterioration thereof over time, the gate-source voltage V_{gs} held in the hold capacitance 120 is always kept constant at “Vᵢₙ+Vₜₕ−ΔV.” The drive transistor 121 operates as a constant current source. Thus, even when the I-V characteristic of the organic EL element 127 changes over time and the source potential Vₛ of the drive transistor 121 changes in association with this, the current flowing to the organic EL element 127 does not change and therefore the emission luminance of the organic EL element 127 is also kept constant because the gate-source voltage V_{gs} of the drive transistor 121 is kept constant Vᵢₙ+Vₜₕ−ΔV) by the hold capacitance 120. Because actually the bootstrap gain is lower than “1,” the gate-source voltage V_{gs} is lower than “Vᵢₙ+Vₜₕ−ΔV.” However, the fact remains that the gate-source voltage V_{gs} is kept at the voltage depending on this bootstrap gain.

As described above, in the pixel circuit 10 of the comparative example and embodiment example 1, threshold correction circuit and mobility correction circuit are automatically configured through devisal for the drive timings. The pixel circuit 10 functions as a drive signal keep-constant circuit that corrects the influence of the threshold voltage Vₜₕ and the carrier mobility μ to keep the drive current constant in order to prevent the influence given to the drive current I_{ds} due to characteristic variation (in the present example, variation in the threshold voltage Vₜₕ and the carrier mobility μ) of the drive transistor 121. Because the pixel circuit 10 carries out not only bootstrap operation but also threshold correction operation and mobility correction operation, the gate-source voltage V_{gs} kept by the bootstrap operation is adjusted by the voltage equivalent to the threshold voltage Vₜₕ and the potential correction value ΔV for mobility correction. Thus, the emission luminance of the organic EL element 127 is not affected by variation in the threshold voltage Vₜₕ and mobility μ of the drive transistor 121 and is not affected also by the deterioration of the organic EL element 127 over time. Displaying can be performed with the stable grayscale corresponding to the input video signal V_{sig} (signal amplitude Vᵢₙ) and a high quality image can be obtained.

Furthermore, the pixel circuit 10 can be configured by a source follower circuit using the n-channel drive transistor 121. Thus, driving of the organic EL element 127 is possible even when an organic EL element having present anode and cathode electrodes is used as it is. Moreover, the pixel circuit 10 can be configured by using only n-channel transistors, including the drive transistor 121, the sampling transistor 125 at the peripheral part thereof, and so forth, and cost reduction can be achieved also in the transistor fabrication.

### [Cause of Occurrence of Display Unevenness Phenomenon]

As described above, in the case of the drive timings shown in FIG. 9, the potential correction value ΔV is ΔV≈I_{ds}·t/Cₑₗ. As is apparent from this equation, the potential correction value ΔV is larger when the drive current I_{ds} as the drain-source current of the drive transistor 121 is larger. Conversely, the potential correction value ΔV is smaller when the drive current I_{ds} of the drive transistor 121 is smaller. In this manner, the potential correction value ΔV is determined depending on the drive current I_{ds}. When the signal amplitude Vᵢₙ is higher, the drive current I_{ds} is larger and the absolute value of the potential correction value ΔV is also larger. Therefore, the mobility correction associated with the emission luminance level can be realized. At this time, writing & mobility correction period H does not necessarily need to be constant. On the contrary, adjusting it depending on the drive current I_{ds} is preferable in some cases. For example, it is preferable that the mobility correction period t be set somewhat short if the drive current I_{ds} is large and conversely writing & mobility correction period H be set somewhat long if the drive current I_{ds} is small.

As described above, the mobility correction is processing of supplying a current to the hold capacitance 120 via the drive transistor 121 while writing the drive voltage corresponding to the video signal V_{sig} to the hold capacitance 120. In this mobility correction, the source potential Vₛ (potential of the second node) is raised by making the current flow through the drive transistor 121 while writing the video signal V_{sig} as described above. However, the source potential Vₛ reaches the threshold voltage V_{thEL} of (light emitting part ELP of) the organic EL element 127 and the organic EL element 127 becomes the state of being turned on in some cases. Due to this, the rise of the source potential Vₛ reflecting the mobility a of the drive transistor 121 is precluded and the correction operation is not normally carried out, which causes uniformity deterioration. For example, if the drive transistor 121 whose mobility μ is excessively large (high) is used, the mobility correction is carried out to an excessive extent. Thus, the collapse of the gate-source voltage V_{gs} immediately before light emission occurs and significant luminance lowering and uniformity lowering occur. To suppress this adverse effect, the width of the mobility correction pulse should be set small for example. However, actually, in the case of operation with the small-width mobility correction pulse, setting and management of the pulse width are difficult in view of the circuit configuration, delay, and other aspects. For example, if the MOSFET is used, the mobility correction is carried out to an excessive extent because the mobility μ thereof is high. Thus, the width of the mobility correction pulse has to be set to about several nanoseconds to prevent luminance lowering. Control of such a small-width pulse is difficult. Taking this point into account, it is desirable to solve the problem without setting the width of the mobility correction pulse small (with the present condition kept substantially).

### [Countermeasure Against Display Unevenness Phenomenon]

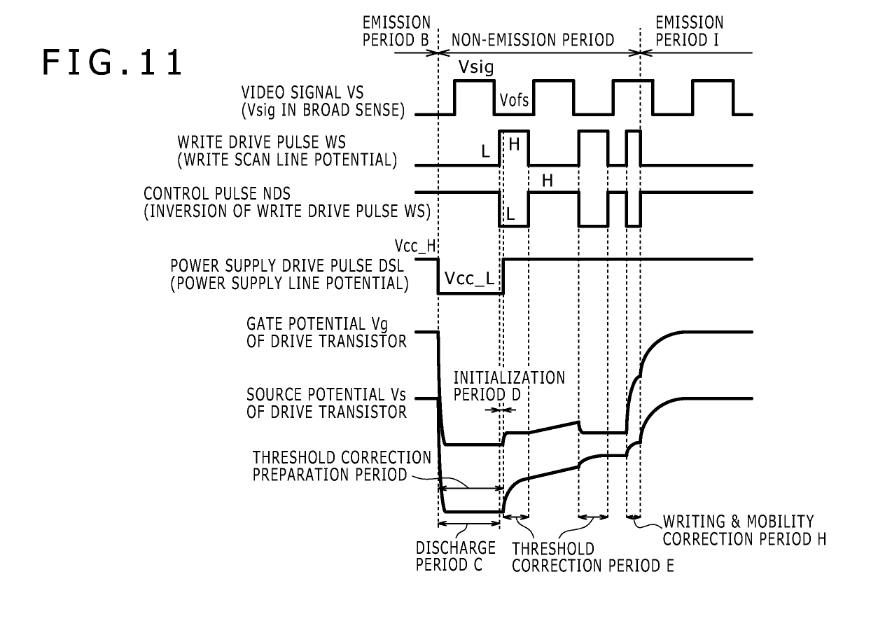

FIG. 11 is a timing chart for explaining the driving method of the pixel circuit of embodiment example 1 with focus on a countermeasure against display unevenness attributed to the turn-on phenomenon of the organic EL element 127 in the mobility correction period. The example shown in the diagram is a case example in which the number of times of initialization operation (initialization period D) for the node ND121 as the first node is only one and the threshold correction operation is repeated three times.

The present embodiment employs a method of solving the display unevenness phenomenon attributed to the turn-on phenomenon of the electro-optical element in the mobility correction period by blocking the current path of the electro-optical element in a “certain period corresponding to mobility correction.” This configuration can prevent the electro-optical element from being turned on due to potential change of the second node in the mobility correction period without setting the width of the mobility correction pulse small (with the present condition kept substantially). It is enough that the “certain period corresponding to mobility correction” is such a period that the electro-optical element is prevented from being turned on by blocking the current path of the electro-optical element in substantially the “mobility correction period.” Thus, some difference may exist between both periods. Specifically, it is enough that the electro-optical element is prevented from being turned on in the mobility correction. Therefore, it is enough that no current is made to flow to the electro-optical element in the mobility correction. Alternatively, it is enough that the current is interrupted before the turning-on even if the current is allowed to flow, and the current may flow to the electro-optical element in some period in the mobility correction period as long as the electro-optical element is not turned on in the mobility correction.

For example, embodiment example 1 employs a method of solving the display unevenness phenomenon by blocking the electrical connection between the node ND122 (second node) and the anode terminal A of the organic EL element 127 (one terminal of the electro-optical element) in the “certain period corresponding to mobility correction.” This configuration can avoid transmission of potential change of the node ND122 in the mobility correction period to the anode terminal A of the organic EL element 127 and can prevent the organic EL element 127 from being turned on in the mobility correction. For example, as shown in FIG. 6 and FIG. 7, in the pixel circuit 10A of embodiment example 1, the current path control transistor 612 is provided between the source terminal of the drive transistor 121 (ND122: second node) and one terminal of the organic EL element 127 (in the diagram, the anode terminal A), and the control pulse NDS obtained by logical inversion of the write drive pulse WS by the inverter 616 is supplied to the control input terminal thereof. Embodiment example 1 has a form in which “difference” hardly exists between the “certain period corresponding to mobility correction” and the mobility correction period. Therefore, the electrical connection between the node ND122 and the anode terminal A of the organic EL element 127 can be blocked almost simultaneously with the start of the mobility correction. Furthermore, the node ND122 can be electrically connected to the anode terminal A of the organic EL element 127 almost simultaneously with the start of the subsequent emission period I (end of mobility correction).

The control pulse NDS is at the L level and the current path control transistor 612 is in the off-state in the period of the mobility correction processing, which is processing of setting the write drive pulse WS to the active-H to turn the sampling transistor 125 to the on-state to thereby supply a current to the hold capacitance 120 via the drive transistor 121 while writing the drive voltage corresponding to the video signal V_{sig} to the hold capacitance 120. Thus, in the mobility correction period (in the diagram, writing & mobility correction period H), the organic EL element 127 does not become the state of being turned on although the source potential Vₛ (potential of the second node) rises up. This can eliminate the phenomenon in which improper mobility correction is carried out and causes uniformity deterioration.

If the potential of the node ND122 (source potential Vₛ) immediately before setting of the current path control transistor 612 to the on-state is different from the potential of the anode terminal A of the organic EL element 127, the potential of the node ND122 (i.e. the anode terminal A of the organic EL element 127) (source potential Vₛ) and the potential of the node ND121 (gate potential V_{g}) slightly decrease immediately after connection accompanying setting of the current path control transistor 612 to the on-state. However, normally this causes no problem.

### Embodiment Example 2

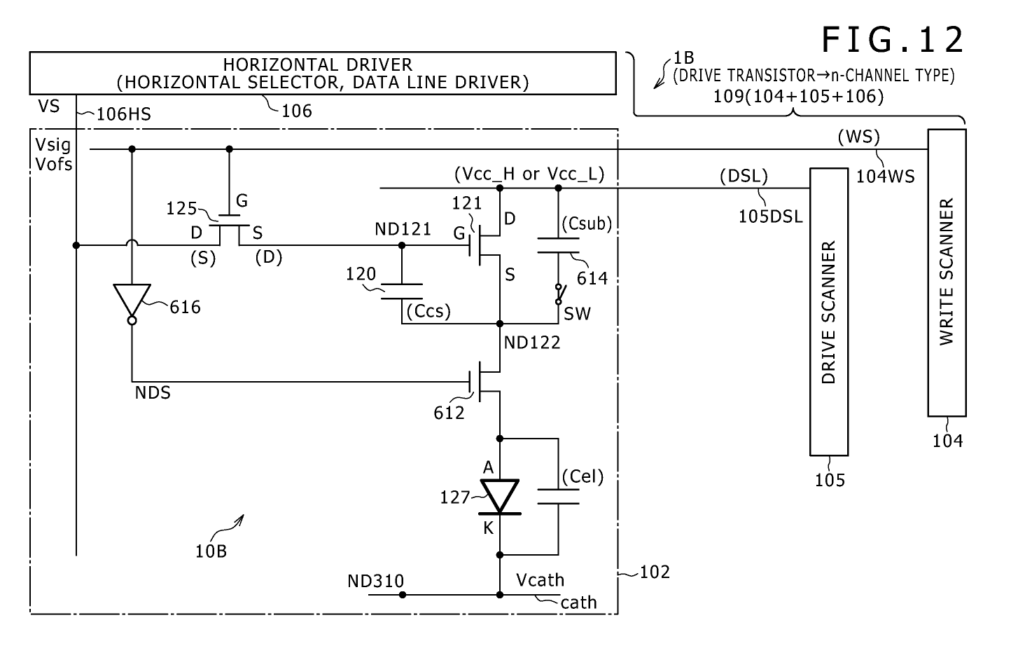

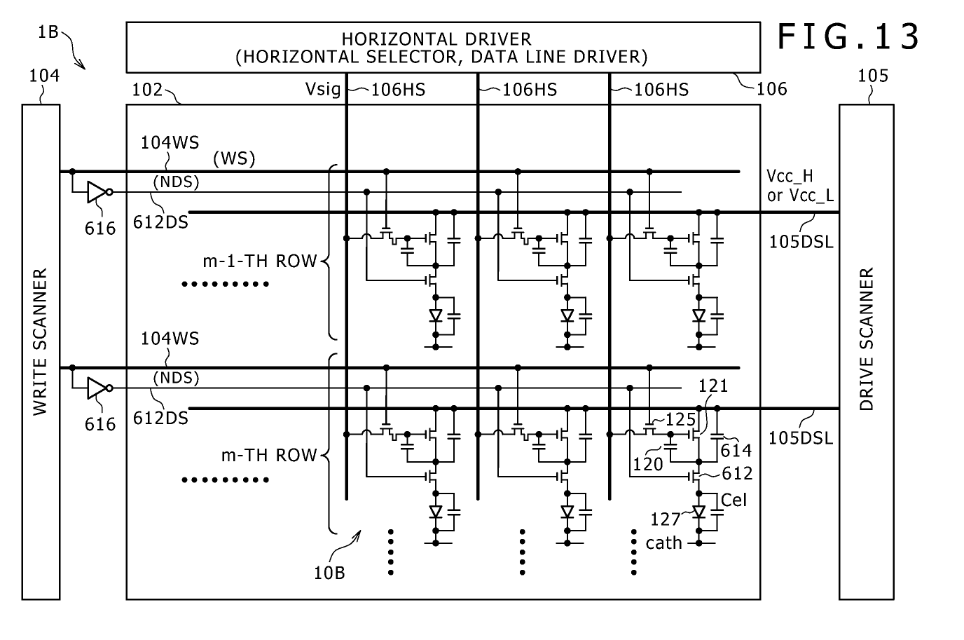

FIG. 12 and FIG. 13 are diagrams showing a pixel circuit 10B of embodiment example 2 and one form of a display device including this pixel circuit 10B. The display device including the pixel circuit 10B of embodiment example 2 in the pixel array section 102 will be referred to as a display device 1B of embodiment example 2. FIG. 12 shows the basic configuration (one pixel) and FIG. 13 shows the specific configuration (whole display device). Although FIG. 13 shows a modification example of the configuration of FIG. 7, the same modification is possible also for the configuration of FIG. 8.

In embodiment example 2, auxiliary capacitance equivalent to the parasitic capacitance Cₑₗ of the organic EL element 127 is connected to the node ND122 for each pixel circuit 10B. Specifically, as shown in FIG. 12 and FIG. 13, the pixel circuit 10B has auxiliary capacitance 614 between the source terminal of the drive transistor 121 (node ND122) and the power supply line 105DSL. Although not shown in the diagram, the auxiliary capacitance 614 may be provided between the source terminal of the drive transistor 121 (node ND122) and the cathode wiring cath or another reference potential node. Although not shown in the diagram, a switch transistor capable of blocking the connection effect of the auxiliary capacitance 614 (i.e. current path to the auxiliary capacitance 614) according to need may be provided. For example, like provision of SW in the diagram, the configuration is so made as to be capable of blocking the connection between the auxiliary capacitance 614 and the power supply line 105DSL or the cathode wiring cath or another reference potential node according to need. This “according to need” means a certain period corresponding to the on-state of the current path control transistor 612 (preferably the same period). It is preferable that the capacitance C_{sub} of the auxiliary capacitance 614 be almost equal to the parasitic capacitance Cₑₗ of (light emitting part ELP of) the organic EL element 127.

In the case of embodiment example 1, the parasitic capacitance Cₑₗ of (light emitting part ELP of) the organic EL element 127 is electrically isolated from the node ND122 in the period of the off-state of the current path control transistor 612. Thus, potential change of the node ND122 is not applied to the anode terminal A of the organic EL element 127 and the organic EL element 127 can be prevented from becoming the turn-on state. However, because the whole of the current from the drive transistor 121 serves as a charge current of the side of the hold capacitance 120, the operation state of the mobility correction period and the threshold correction period is different from that when the current path control transistor 612 does not exist. In embodiment example 2, taking this point into account, the auxiliary capacitance 614 is provided so that the operation state of the mobility correction period and the threshold correction period may be substantially the same as that when the current path control transistor 612 does not exist also in the period of the off-state of the current path control transistor 612. In addition, preferably the capacitance C_{sub} thereof is set substantially equal to the parasitic capacitance Cₑₗ of the organic EL element 127. In the example shown in the diagram, the auxiliary capacitance 614 remains connected also in the period of the on-state of the current path control transistor 612. However, normally this causes no particular inconvenience. If inconvenience is caused when it remains connected, a switch transistor capable of blocking the connection between them in the period of the on-state of the current path control transistor 612 is provided as described above.

### Embodiment Example 3

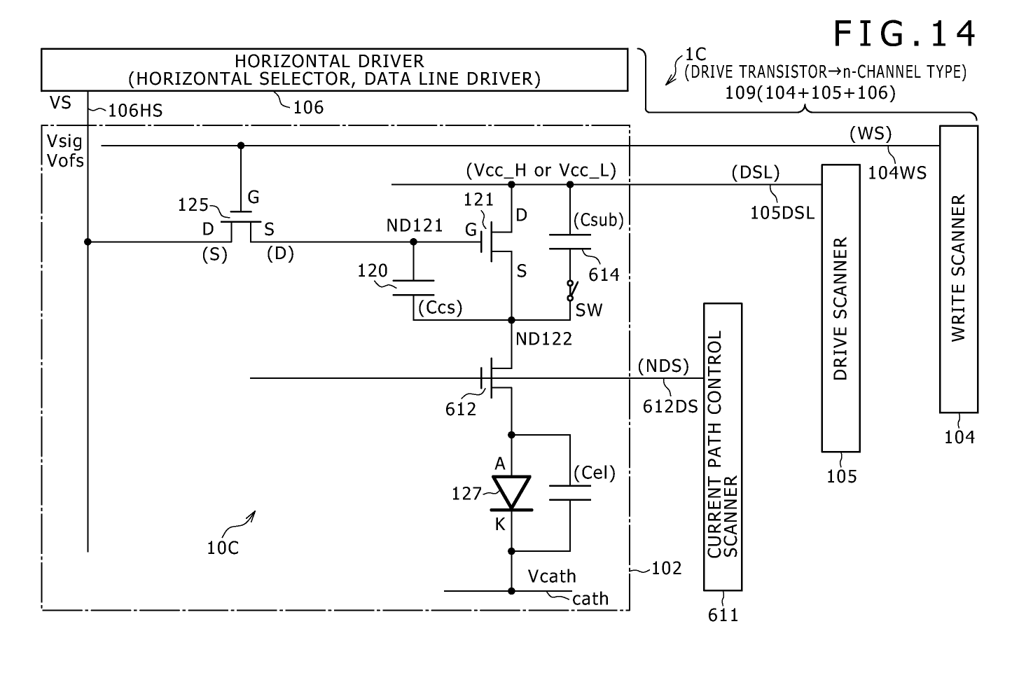

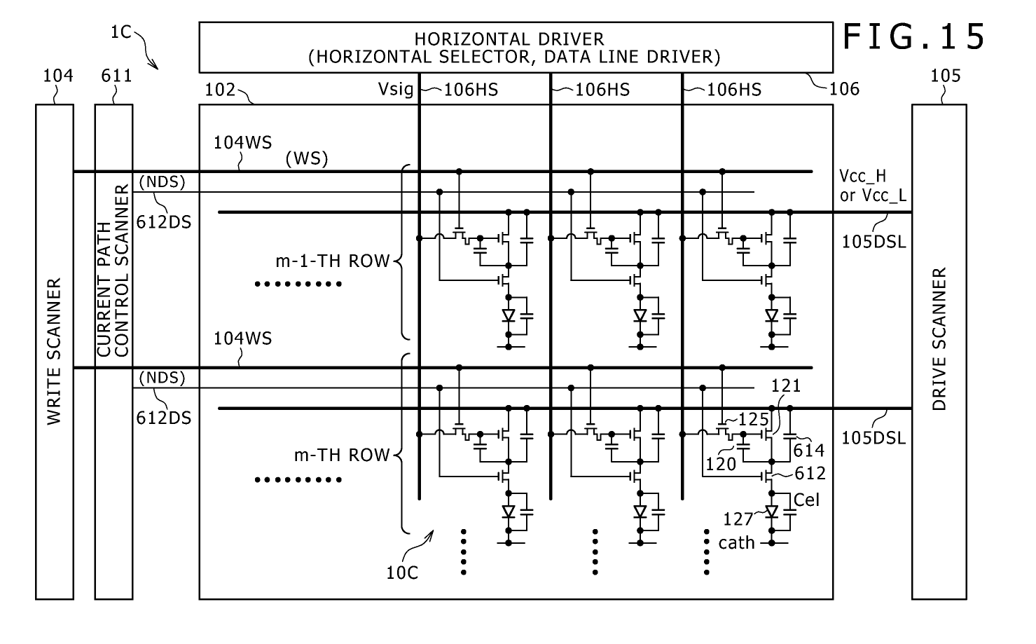

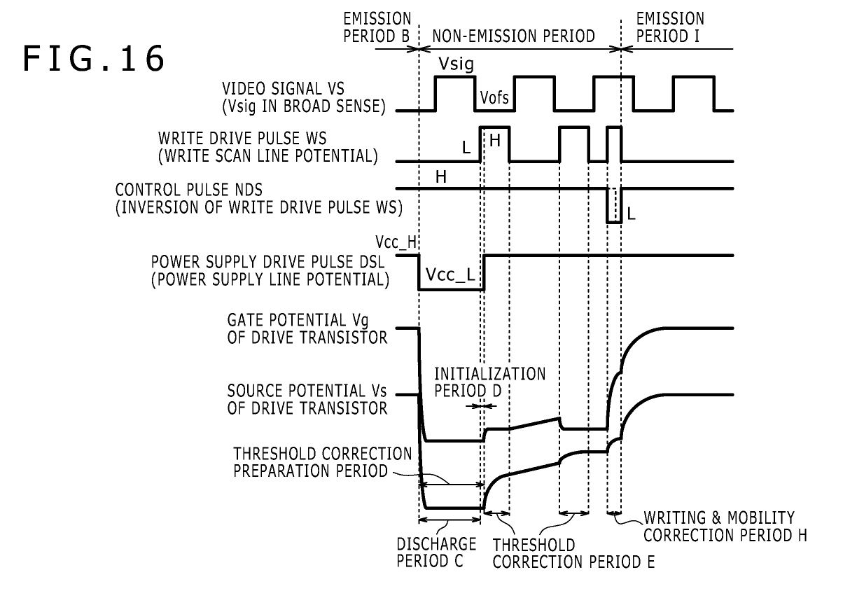

FIG. 14 to FIG. 16 are diagrams showing a pixel circuit 10C of embodiment example 3 and one form of a display device including this pixel circuit 10C. The display device including the pixel circuit 10C of embodiment example 3 in the pixel array section 102 will be referred to as a display device 1C of embodiment example 3. FIG. 14 shows the basic configuration (one pixel) and FIG. 15 shows the specific configuration (whole display device). Although FIG. 15 shows a modification example of the configuration of FIG. 13 of embodiment example 2, the same modification is possible also for the configurations of FIG. 7 and FIG. 8 of embodiment example 1. FIG. 16 is a timing chart for explaining the driving method of the pixel circuit of embodiment example 3 with focus on a countermeasure against display unevenness attributed to the turn-on phenomenon of the organic EL element 127 in the mobility correction period.

As shown in FIG. 14 and FIG. 15, in embodiment example 3, instead of providing the inverter 616, a current path control scanner 611 that carries out on/off-control of the current path control transistor 612 independently of the write drive pulse WS is provided outside the pixel array section 102. The current path control scanner 611 and the current path control transistor 612 configure a control section that carries out blocking control of the current path of the display part in association with processing of supplying a current to the hold capacitance via the drive transistor while writing the drive voltage corresponding to the video signal to the hold capacitance.

The current path control scanner 611 generates the control pulse NDS for blocking the current path of the organic EL element 127 (electro-optical element) in the “certain period corresponding to mobility correction” and supplies the control pulse NDS in common to the control input terminals of the current path control transistors 612 on the same row via a current path control scan line 612DS. The “certain period corresponding to mobility correction” is, in other words, a “certain period corresponding to processing of supplying a current to the hold capacitance via the drive transistor while writing the drive voltage corresponding to the video signal to the hold capacitance.”

In embodiment example 1 and embodiment example 2, the control pulse NDS is generated by logical inversion of the write drive pulse WS by the inverter 616. Alternatively, although not shown in the diagram, the write drive pulse WS itself is used as the control pulse NDS if a p-channel transistor is used as the current path control transistor 612. Thus, there is no flexibility in the timing setting of the control pulse NDS. Therefore, the on/off-operation of the current path control transistor 612 is substantially complementary operation for the on/off-operation of the sampling transistor 125, and opening/closing of the current path of the organic EL element 127 is controlled in association with the write drive pulse. In contrast, in embodiment example 3, the control pulse NDS can be generated independently of the write drive pulse WS. Thus, the timing setting of the control pulse NDS has flexibility and opening/closing of the current path of the organic EL element 127 can be controlled independently of the write drive pulse. For example, as shown in FIG. 16, it is also possible that the control pulse NDS is set to the H-state in threshold correction period E and is set to the L-state only in mobility correction period (in this example, writing & mobility correction period H). In embodiment example 1 and embodiment example 2, when the current path control transistor 612 is turned to the on-state at the end timing of threshold correction period E, the gate potential V_{g} and the source potential Vₛ change at the moment of the turning-on of the added current path control transistor 612 because the source potential Vₛ immediately before the turning-on is different from the potential of the anode terminal A of the organic EL element 127. In contrast, in embodiment example 3, the current path control transistor 612 is in the on-state also in threshold correction period E. Thus, the influence of provision of the current path control transistor 612 on the threshold correction processing can be completely eliminated.

As shown by the dashed line in FIG. 16, it is also possible to keep the control pulse NDS at the H-state in the first half of writing & mobility correction period H and set the control pulse NDS to the L-state only in the second half. In this case, the potential of the anode terminal A of the organic EL element 127 can be raised to such an extent that the organic EL element 127 is not turned on in the first half of writing & mobility correction period H. This can decrease the difference between the potential of the node ND122 (source potential Vₛ) immediately before setting of the current path control transistor 612 to the on-state and the potential of the anode terminal A of the organic EL element 127. This is the same also when the control pulse NDS is set to the L-state only in the first half of writing & mobility correction period H and the control pulse NDS is set to the H-state in the second half. Thus, changes in the potential of the node ND122 (i.e. anode terminal A of the organic EL element 127) (source potential Vₛ) and the potential of the node ND121 (gate potential V_{g}) immediately after connection accompanying setting of the current path control transistor 612 to the on-state can be made smaller than those in embodiment example 1 and embodiment example 2.

### Embodiment Example 4

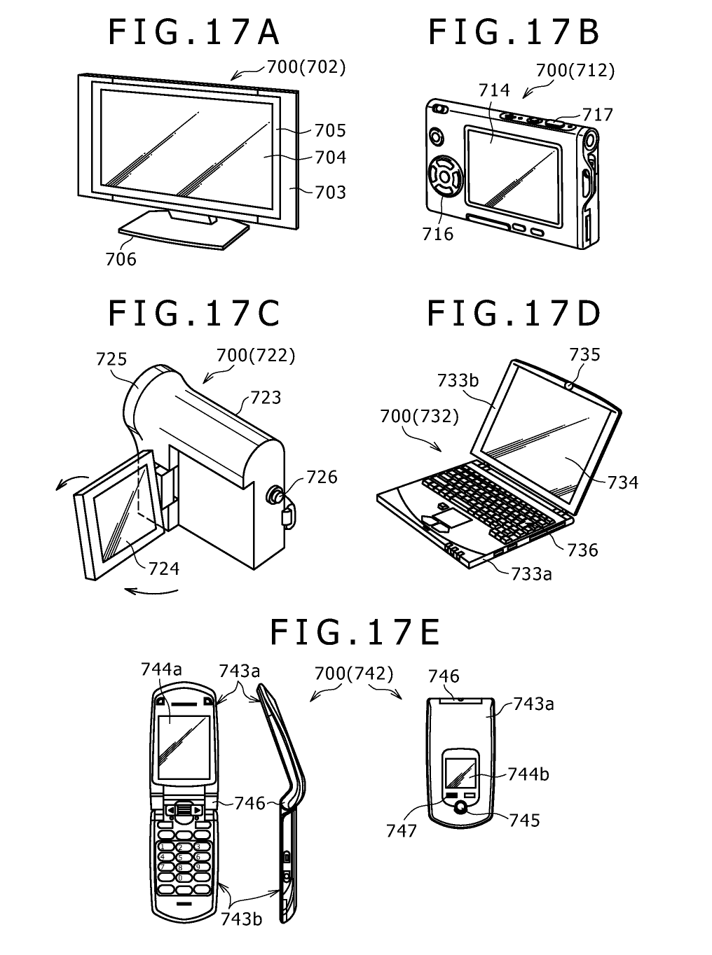

FIG. 17 is a diagram for explaining embodiment example 4. Embodiment example 4 is case examples about electronic apparatus equipped with the display device to which the above-described technique to suppress and eliminate display unevenness attributed to the turn-on phenomenon of the organic EL element 127 in the mobility correction period is applied. The display unevenness suppression processing of the present embodiment can be applied to a display device having current-driven display elements used for various kinds of electronic apparatus such as game machine, electronic book, electronic dictionary, and cellular phone.

For example, FIG. 17A is a perspective view showing an appearance example when electronic apparatus 700 is a television receiver 702 utilizing a display module 704 as one example of an image display device. The television receiver 702 has a structure in which the display module 704 is disposed on the front face of a front panel 703 supported by a base 706 and a filter glass 705 is provided on the display surface. FIG. 17B is a diagram showing an appearance example when the electronic apparatus 700 is a digital camera 712. The digital camera 712 includes a display module 714, a control switch 716, a shutter button 717, and other components. FIG. 17C is a diagram showing an appearance example when the electrode apparatus 700 is a video camcorder 722. In the video camcorder 722, an imaging lens 725 for imaging of a subject is provided on the front side of a main body 723, and in addition, a display module 724, a start/stop switch 726 of photographing, and so forth are disposed. FIG. 17D is a diagram showing an appearance example when the electronic apparatus 700 is a computer 732. The computer 732 includes a lower chassis 733a, an upper chassis 733b, a display module 734, a Web camera 735, a keyboard 736, etc. FIG. 17E is a diagram showing an appearance example when the electronic apparatus 700 is a cellular phone 742. The cellular phone 742 is a foldable type and includes an upper chassis 743a, a lower chassis 743b, a display module 744a, a sub-display 744b, a camera 745, a coupling part 746 (in this example, hinge part), a picture light 747, etc.

The display module 704, the display module 714, the display module 724, the display module 734, the display module 744a, and the sub-display 744b are fabricated by using the display device of the present embodiment. Due to this, the respective pieces of electronic apparatus 700 can correct luminance variation attributed to variation in the threshold voltage and mobility of the drive transistor (and variation in k). In addition, they can suppress and eliminate display unevenness attributed to the turn-on phenomenon of the organic EL element 127 in the mobility correction period and can perform displaying with high image quality.

Although the technique disclosed in the present specification is explained by using the embodiment, the technical scope of the contents set forth in the claims is not limited to the range described in the above embodiment. A variety of changes or improvements can be added to the above-described embodiment without departing from the gist of the technique disclosed in the present specification and such a form to which the change or improvement is added is also included in the technical range of the technique disclosed in the present specification. The above-described embodiment does not limit the techniques according to the claims and all of the combinations of the characteristics explained in the embodiment are not always essential for the solutions to the problems as the subject of the technique disclosed in the present specification. Techniques of various stages are included in the above-described embodiment and various techniques can be extracted by proper combinations in the plural disclosed constituent requirements. Even if several constituent requirements are removed from all constituent requirements shown in the embodiment, this configuration from which several constituent requirements are removed can also be extracted as the technique disclosed in the present specification as long as an effect responding to the problems as the subject of the technique disclosed in the present specification is obtained.

For example, an n-channel transistor is used as the current path control transistor 612 in embodiment example 1 to embodiment example 3. However, this is not essential and it is also possible to use a p-channel transistor. In this case, a control pulse having the same polarity as that of the write drive pulse WS is supplied to the control input terminal of this p-channel transistor.

In embodiment example 1 to embodiment example 3, the current path control transistor 612 is provided between the node ND122 and the anode terminal A of the organic EL element 127. However, this is not essential and another configuration may be employed as long as it can control opening and closing of the current path of the organic EL element 127 in the “certain period corresponding to mobility correction.” For example, although not shown in the diagram, the current path control transistor 612 may be provided between the cathode terminal K of the organic EL element 127 and the cathode wiring cath.

Furthermore, in terms of suppression of display unevenness attributed to turning-on of the electro-optical element in processing of supplying a current to the hold capacitance via the drive transistor while writing the drive voltage corresponding to the video signal to the hold capacitance (corresponding to mobility correction processing), it is enough that the configuration is so made as to be capable of carrying out control to prevent at least the turning-on of the electro-optical element in the period of this processing, and various configurations can be employed as long as this condition is satisfied. It is not essential to realize a configuration coping with this through devisal of the control timings of the pixel circuit 10 by the control section 109 (in the above-described example, current path control scanner 611) provided outside the pixel circuit like embodiment example 3. A circuit element for coping with this may be included in the pixel circuit like embodiment example 1 and embodiment example 2. That is, the current path blocking control section that blocks the current path of the electro-optical element in association with processing of supplying a current to the hold capacitance via the drive transistor while writing the drive voltage corresponding to the video signal to the hold capacitance may be provided for each pixel circuit.

Alternatively, without providing the independent current path control scanner 611 outside the pixel circuit 10 differently from embodiment example 3, the control pulse NDS may be generated by a logic circuit with use of a drive pulse output by another scanner and the current path control transistor 612 may be controlled by the control pulse NDS.

As the electronic component to block the current path of the electro-optical element in association with processing of writing the drive voltage corresponding to the video signal to the hold capacitance, the current path control transistor 612 is used as the current path control transistor. However, another switch component may be used. It is obvious that it is possible to employ a complementary configuration obtained e.g. by interchanging the transistor between n-channel and p-channel and reversing the polarity of the power supply and the signals in association with this interchange.

When the description of the above embodiment is taken into account, the techniques according to the claims set forth in the scope of patent claims are one example and e.g. the following techniques are extracted. They will be listed below.

### [Appended Note 1]

A pixel circuit including:

a display part;

hold capacitance;

a write transistor that writes a drive voltage corresponding to a video signal to the hold capacitance; and

a drive transistor that drives the display part based on the drive voltage written to the hold capacitance,

wherein the pixel circuit is so configured as to be capable of controlling opening and closing of a current path of the display part in association with processing of writing the drive voltage corresponding to the video signal to the hold capacitance.

### [Appended Note 2]

The pixel circuit according to appended note 1,

wherein control is so carried out that the current path of the display part is blocked in a certain period corresponding to processing of supplying a current to the hold capacitance via the drive transistor while supplying the video signal to a control input terminal of the drive transistor and one terminal of the hold capacitance via the write transistor.

### [Appended Note 3]

The pixel circuit according to appended note 1 or appended note 2, further including

a current path control transistor capable of controlling opening and closing of the current path of the display part.

### [Appended Note 4]

The pixel circuit according to appended note 3,

wherein the current path control transistor is controlled in association with a write drive pulse to control the write transistor.

### [Appended Note 5]

The pixel circuit according to appended note 3,

wherein the current path control transistor is controlled independently of a write drive pulse to control the write transistor.

### [Appended Note 6]

The pixel circuit according to one of appended note 1 to appended note 5,

wherein one terminal of auxiliary capacitance is connected to a connecting node between the other terminal of the hold capacitance and one main electrode terminal of the drive transistor, and

the other terminal of the auxiliary capacitance is connected to a predetermined reference potential node.

### [Appended Note 7]

The pixel circuit according to appended note 6,

wherein the auxiliary capacitance has substantially the same capacitance value as a capacitance value of parasitic capacitance of the display part.

### [Appended Note 8]

The pixel circuit according to appended note 6 or appended note 7,

wherein connection of the auxiliary capacitance is so configured as to be capable of being blocked in association with the processing of writing the drive voltage corresponding to the video signal to the hold capacitance.

### [Appended Note 9]

The pixel circuit according to one of appended note 1 to appended note 8,

wherein processing of supplying a current to the hold capacitance via the drive transistor while supplying the video signal to a control input terminal of the drive transistor and one terminal of the hold capacitance via the write transistor is used for mobility correction processing to correct mobility of the drive transistor.

### [Appended Note 10]

The pixel circuit according to one of appended note 1 to appended note 9,

wherein processing of supplying a current to the hold capacitance via the drive transistor is executed after correction processing of a threshold voltage of the drive transistor.

### [Appended Note 11]

The pixel circuit according to appended note 10,

wherein the current path of the display part is not blocked in the correction processing of the threshold voltage.

### [Appended Note 12]

The pixel circuit according to one of appended note 1 to appended note 11, further including

a pixel section configured to include the display parts that are arranged,

wherein a characteristic control section controls a characteristic of the drive transistor for each of the display parts.

### [Appended Note 13]

The pixel circuit according to appended note 12,

wherein the display parts are arranged in a two-dimensional matrix manner in the pixel section.

### [Appended Note 14]

The pixel circuit according to one of appended note 1 to appended note 13, further including

a control section that carries out blocking control of the current path of the display part in association with processing of supplying a current to the hold capacitance via the drive transistor while writing the drive voltage corresponding to the video signal to the hold capacitance.

### [Appended Note 15]

The pixel circuit according to one of appended note 1 to appended note 14,

wherein the display part is a self-luminous type.

### [Appended Note 16]

The pixel circuit according to appended note 15,

wherein the display part has an organic electroluminescence light emitting part.

### [Appended Note 17]

A display device including:

display elements that are arranged and include a display part, hold capacitance, a write transistor that writes a drive voltage corresponding to a video signal to the hold capacitance, and a drive transistor that drives the display part based on the drive voltage written to the hold capacitance; and

a control section capable of controlling opening and closing of a current path of the display part in association with processing of writing the drive voltage corresponding to the video signal to the hold capacitance.

### [Appended Note 18]

The display device according to appended note 17,

wherein a current path control transistor capable of controlling opening and closing of the current path of the display part is provided for each of the display elements, and

a current path control scanner that carries out on/off-control of the current path control transistor is provided.

### [Appended Note 19]

An electronic apparatus including:

a pixel section configured to include display elements that are arranged and include a display part, hold capacitance, a write transistor that writes a drive voltage corresponding to a video signal to the hold capacitance, and a drive transistor that drives the display part based on the drive voltage written to the hold capacitance;

a signal generator that generates the video signal to be supplied to a pixel section; and

a control section capable of controlling opening and closing of a current path of the display part in association with processing of writing the drive voltage corresponding to the video signal to the hold capacitance.

### [Appended Note 20]

A method for driving a pixel circuit including a drive transistor that drives a display part, the method including

controlling opening and closing of a current path of the display part in association with processing of writing a drive voltage corresponding to a video signal to hold capacitance.

The present technology contains subject matter related to that disclosed in Japanese Priority Patent Application JP 2011-107911 filed in the Japan Patent Office on May 13, 2011, the entire content of which is hereby incorporated by reference.

What is claimed is:

1. A pixel circuit comprising:
a display part;
hold capacitance;
a write transistor configured to write a drive voltage corresponding to a video signal to the hold capacitance; and
a drive transistor configured to drive the display part based on the drive voltage written to the hold capacitance,
wherein the pixel circuit is so configured as to be capable of controlling opening and closing of a current path of the display part in association with processing of writing the drive voltage corresponding to the video signal to the hold capacitance.

2. The pixel circuit according to claim 1,
wherein control is so carried out that the current path of the display part is blocked in a certain period corresponding to processing of supplying a current to the hold capacitance via the drive transistor while supplying the video signal to one terminal of the hold capacitance via the write transistor.

3. The pixel circuit according to claim 1, further comprising
a current path control transistor configured to be capable of controlling opening and closing of the current path of the display part.

4. The pixel circuit according to claim 3,
wherein the current path control transistor is controlled in association with a write drive pulse to control the write transistor.

5. The pixel circuit according to claim 3,
wherein the current path control transistor is controlled independently of a write drive pulse to control the write transistor.

6. The pixel circuit according to claim 1,
wherein one terminal of auxiliary capacitance is connected to a connecting node between the other terminal of the hold capacitance and one main electrode terminal of the drive transistor, and
the other terminal of the auxiliary capacitance is connected to a predetermined reference potential node.

7. The pixel circuit according to claim 6,
wherein the auxiliary capacitance has substantially the same capacitance value as a capacitance value of parasitic capacitance of the display part.

8. The pixel circuit according to claim 6,
wherein connection of the auxiliary capacitance is so configured as to be capable of being blocked in association with the processing of writing the drive voltage corresponding to the video signal to the hold capacitance.

9. The pixel circuit according to claim 1,
wherein processing of supplying a current to the hold capacitance via the drive transistor while supplying the video signal to one terminal of the hold capacitance via the write transistor is used for mobility correction processing to correct mobility of the drive transistor.

10. The pixel circuit according to claim 1,
wherein processing of supplying a current to the hold capacitance via the drive transistor is executed after correction processing of a threshold voltage of the drive transistor.

11. The pixel circuit according to claim 10,
wherein the current path of the display part is not blocked in the correction processing of the threshold voltage.

12. The pixel circuit according to claim 1, further comprising
a pixel section configured to include the display parts that are arranged,
wherein a characteristic control section controls a characteristic of the drive transistor for each of the display parts.

13. The pixel circuit according to claim 12,
wherein the display parts are arranged in a two-dimensional matrix manner in the pixel section.

14. The pixel circuit according to claim 1, further comprising
a control section configured to carry out blocking control of the current path of the display part in association with processing of supplying a current to the hold capacitance via the drive transistor while writing the drive voltage corresponding to the video signal to the hold capacitance.

15. The pixel circuit according to claim 1,
wherein the display part is a self-luminous type.

16. The pixel circuit according to claim 15,
wherein the display part has an organic electroluminescence light emitting part.

17. A display device comprising:
display elements configured to be arranged and include a display part, hold capacitance, a write transistor that writes a drive voltage corresponding to a video signal to the hold capacitance, and a drive transistor that drives the display part based on the drive voltage written to the hold capacitance; and
a control section configured to be capable of controlling opening and closing of a current path of the display part in association with processing of writing the drive voltage corresponding to the video signal to the hold capacitance.

18. The display device according to claim 17,
wherein a current path control transistor capable of controlling opening and closing of the current path of the display part is provided for each of the display elements, and
a current path control scanner that carries out on/off-control of the current path control transistor is provided.

19. An electronic apparatus comprising:
a pixel section configured to include display elements that are arranged and include a display part, hold capacitance, a write transistor that writes a drive voltage corresponding to a video signal to the hold capacitance, and a drive transistor that drives the display part based on the drive voltage written to the hold capacitance;
a signal generator configured to generate the video signal to be supplied to the pixel section; and
a control section configured to be capable of controlling opening and closing of a current path of the display part in association with processing of writing the drive voltage corresponding to the video signal to the hold capacitance.

20. A method for driving a pixel circuit including a drive transistor that drives a display part, the method comprising
controlling opening and closing of a current path of the display part in association with processing of writing a drive voltage corresponding to a video signal to hold capacitance.
